(19) United States
(12) Patent Application Publication
(10) Pub. No.: US 2025/0245797 A1
(43) Pub. Date: Jul. 31, 2025

(54) MODIFYING THE BRIGHTNESS OF USER INTERFACES

(71) Applicant: Apple Inc., Cupertino, CA (US)

(72) Inventors: Nathan DE VRIES, Alameda, CA (US); Grant R. PAUL, San Francisco, CA (US); Michael S. SOETAERT, San Jose, CA (US)

(21) Appl. No.: 19/008,285

(22) Filed: Jan. 2, 2025

Related U.S. Application Data
(60) Provisional application No. 63/654,867, filed on May 31, 2024.
(60) Provisional application No. 63/625,791, filed on Jan. 26, 2024.

(51) Int. Cl. G06T 5/92; G06T 7/194; G06T 11/60; G06V 20/40; H04M 1/72472

(52) U.S. Cl. CPC G06T 5/92; G06T 7/194; G06T 11/60; G06V 20/44; G06T 2200/24; G06T 2207/20208; H04M 1/72472

(57) ABSTRACT

The present disclosure generally relates to increasing the brightness of user interface objects.

### CROSS-REFERENCE TO RELATED APPLICATIONS

This application claims priority to U.S. Provisional Patent Application Ser. No. 63/654,867, filed on May 31, 2024, entitled “MODIFYING THE BRIGHTNESS OF USER INTERFACES,” and claims priority to U.S. Provisional Patent Application Ser. No. 63/625,791, filed on Jan. 26, 2024, and entitled “MODIFYING THE BRIGHTNESS OF USER INTERFACES,” the contents of which are hereby incorporated by reference in their entirety.

### FIELD

The present disclosure relates generally to computer user interfaces, and more specifically to techniques for modifying the brightness of user interfaces.

### BACKGROUND

Computer systems display media, such as photos and/or videos, that includes bright media content. The bright media content causes user interface objects of user interfaces and/or applications to be dark.

### BRIEF SUMMARY

Some techniques for modifying the brightness of user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices. Further, existing techniques do not brighten specific user interface objects based on bright media content. This is cumbersome to a user because it is difficult for a user to interact with user interface objects that are located near the bright media content.

Accordingly, the present technique provides electronic devices with faster, more efficient methods and techniques for modifying the brightness of user interfaces. Such methods and interfaces optionally complement or replace other methods for modifying the brightness of user interfaces. Such methods and techniques reduce the cognitive burden on a user and produce a more efficient human-machine interface. For battery-operated computing devices, such methods and techniques conserve power and increase the time between battery charges. Additionally, the present technique reduces or prevents the need to keep the whole display in an HDR range, which would use significantly more power and have the potential to increase burn in or otherwise increase wear and tear on the display and decrease the lifespan of the display. Conditionally displaying HDR content and increasing the brightness of only portions of the display thus reduces power usage and avoids issues with burn in and wearing out the display in other ways.

In accordance with some embodiments, a method performed at a computer system that is in communication with a display generation component and one or more input devices is described. The method comprises: receiving, via the one or more input devices, a request to display media; and in response to receiving the request to display the media: displaying, via the display generation component and concurrently with a first user interface that includes a user interface object, different from the media, a portion of the media; and in accordance with a determination that a first set of criteria is satisfied, wherein the first set of criteria includes a first criterion that is satisfied when the portion of the media includes content that is displayed above a threshold brightness, increasing a brightness of a first portion of the user interface object relative to a brightness of a second portion of the user interface object.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: receiving, via the one or more input devices, a request to display media; and in response to receiving the request to display the media: displaying, via the display generation component and concurrently with a first user interface that includes a user interface object, different from the media, a portion of the media; and in accordance with a determination that a first set of criteria is satisfied, wherein the first set of criteria includes a first criterion that is satisfied when the portion of the media includes content that is displayed above a threshold brightness, increasing a brightness of a first portion of the user interface object relative to a brightness of a second portion of the user interface object.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: receiving, via the one or more input devices, a request to display media; and in response to receiving the request to display the media: displaying, via the display generation component and concurrently with a first user interface that includes a user interface object, different from the media, a portion of the media; and in accordance with a determination that a first set of criteria is satisfied, wherein the first set of criteria includes a first criterion that is satisfied when the portion of the media includes content that is displayed above a threshold brightness, increasing a brightness of a first portion of the user interface object relative to a brightness of a second portion of the user interface object.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: receiving, via the one or more input devices, a request to display media; and in response to receiving the request to display the media: displaying, via the display generation component and concurrently with a first user interface that includes a user interface object, different from the media, a portion of the media; and in accordance with a determination that a first set of criteria is satisfied, wherein the first set of criteria includes a first criterion that is satisfied when the portion of the media includes content that is displayed above a threshold brightness, increasing a brightness of a first portion of the user interface object relative to a brightness of a second portion of the user interface object.

In accordance with some embodiments, a computer system that is configured to communicate with a display generation component and one or more input devices is described. The computer system comprises: means for receiving, via the one or more input devices, a request to display media; and means for in response to receiving the request to display the media: displaying, via the display generation component and concurrently with a first user interface that includes a user interface object, different from the media, a portion of the media; and in accordance with a determination that a first set of criteria is satisfied, wherein the first set of criteria includes a first criterion that is satisfied when the portion of the media includes content that is displayed above a threshold brightness, increasing a brightness of a first portion of the user interface object relative to a brightness of a second portion of the user interface object.

In accordance with some embodiments, a computer program product is described. The computer program product comprises one or more programs configured to be executed by one or more processors of a computer system that is that is in communication with a display generation component and one or more input devices. The one or more programs include instructions for: receiving, via the one or more input devices, a request to display media; and in response to receiving the request to display the media: displaying, via the display generation component and concurrently with a first user interface that includes a user interface object, different from the media, a portion of the media; and in accordance with a determination that a first set of criteria is satisfied, wherein the first set of criteria includes a first criterion that is satisfied when the portion of the media includes content that is displayed above a threshold brightness, increasing a brightness of a first portion of the user interface object relative to a brightness of a second portion of the user interface object.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: detecting an event corresponding to a request to display a user interface that has an appearance that is based on the event; and in response to detecting the event, displaying, via the display generation component, a user interface that has an appearance that is based on the event, wherein the user interface includes first content that includes at least a portion that has a target brightness that is outside of a standard range of brightness for the display generation component, including: in accordance with a determination that the first content is in a foreground, displaying, via the display generation component, the first content with a brightness that is above the standard range of brightness for the display generation component; and in accordance with a determination that the first content is not in the foreground, displaying, via the display generation component, the first content with a brightness that is within the standard range of brightness for the display generation component.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: detecting an event corresponding to a request to display a user interface that has an appearance that is based on the event; and in response to detecting the event, displaying, via the display generation component, a user interface that has an appearance that is based on the event, wherein the user interface includes first content that includes at least a portion that has a target brightness that is outside of a standard range of brightness for the display generation component, including: in accordance with a determination that the first content is in a foreground, displaying, via the display generation component, the first content with a brightness that is above the standard range of brightness for the display generation component; and in accordance with a determination that the first content is not in the foreground, displaying, via the display generation component, the first content with a brightness that is within the standard range of brightness for the display generation component.

In accordance with some embodiments, a computer system is described. The computer system is configured to communicate with a display generation component and comprises: one or more processors; and memory storing one or more programs configured to be executed by the one or more processors, the one or more programs including instructions for: detecting an event corresponding to a request to display a user interface that has an appearance that is based on the event; and in response to detecting the event, displaying, via the display generation component, a user interface that has an appearance that is based on the event, wherein the user interface includes first content that includes at least a portion that has a target brightness that is outside of a standard range of brightness for the display generation component, including: in accordance with a determination that the first content is in a foreground, displaying, via the display generation component, the first content with a brightness that is above the standard range of brightness for the display generation component; and in accordance with a determination that the first content is not in the foreground, displaying, via the display generation component, the first content with a brightness that is within the standard range of brightness for the display generation component.

In accordance with some embodiments, a computer system is described. The computer system is configured to communicate with a display generation component and comprises: means for detecting an event corresponding to a request to display a user interface that has an appearance that is based on the event; and means, responsive to detecting the event, for displaying, via the display generation component, a user interface that has an appearance that is based on the event, wherein the user interface includes first content that includes at least a portion that has a target brightness that is outside of a standard range of brightness for the display generation component, including: in accordance with a determination that the first content is in a foreground, displaying, via the display generation component, the first content with a brightness that is above the standard range of brightness for the display generation component; and in accordance with a determination that the first content is not in the foreground, displaying, via the display generation component, the first content with a brightness that is within the standard range of brightness for the display generation component.

In accordance with some embodiments, a computer program product is described. The computer program product comprises one or more programs configured to be executed by one or more processors of a computer system that is in communication with a display generation component, the one or more programs including instructions for: detecting an event corresponding to a request to display a user interface that has an appearance that is based on the event; and in response to detecting the event, displaying, via the display generation component, a user interface that has an appearance that is based on the event, wherein the user interface includes first content that includes at least a portion that has a target brightness that is outside of a standard range of brightness for the display generation component, including: in accordance with a determination that the first content is in a foreground, displaying, via the display generation component, the first content with a brightness that is above the standard range of brightness for the display generation component; and in accordance with a determination that the first content is not in the foreground, displaying, via the display generation component, the first content with a brightness that is within the standard range of brightness for the display generation component.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and techniques for modifying the brightness of user interface objects, thereby increasing the effectiveness, efficiency, and user satisfaction with such devices. Such methods and techniques may complement or replace other methods for modifying the brightness of user interface objects.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G illustrate block diagrams illustrating example devices and flow diagrams illustrating example methods, in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6K illustrate exemplary user interfaces for modifying the brightness of user interface objects, in accordance with some embodiments.

FIG. 7 is a flow diagram illustrating a method for modifying the brightness of user interface objects, in accordance with some embodiments.

FIGS. 8A-8K illustrate example user interfaces for modifying the brightness of user interface objects, in accordance with some embodiments.

FIG. 9 is a flow diagram illustrating a method for modifying the brightness of user interface objects, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

Electronic devices optionally display bright media content. The brightness of the bright media content causes nearby user interface objects appear dark, making it difficult for a user to interact with and/or view user interface objects (e.g., buttons, text input fields, and/or text) that are close to the bright media content. There is a need for electronic devices that provide efficient methods and techniques for modifying the brightness of user interface objects. Such techniques can reduce the cognitive burden on a user who wants to interact with user interface objects that are located near the bright media content, thereby enhancing productivity. Further, such techniques can reduce processor and battery power otherwise wasted on redundant user inputs. Additionally, the present technique prevents or reduces the need to keep the whole display in an HDR range, which would use significantly more power and have the potential to increase burn in or otherwise increase wear and tear on the display and decrease the lifespan of the display. Conditionally displaying HDR content and increasing the brightness of only portions of the display thus reduces power usage and avoids issues with burn in and wearing out the display in other ways.

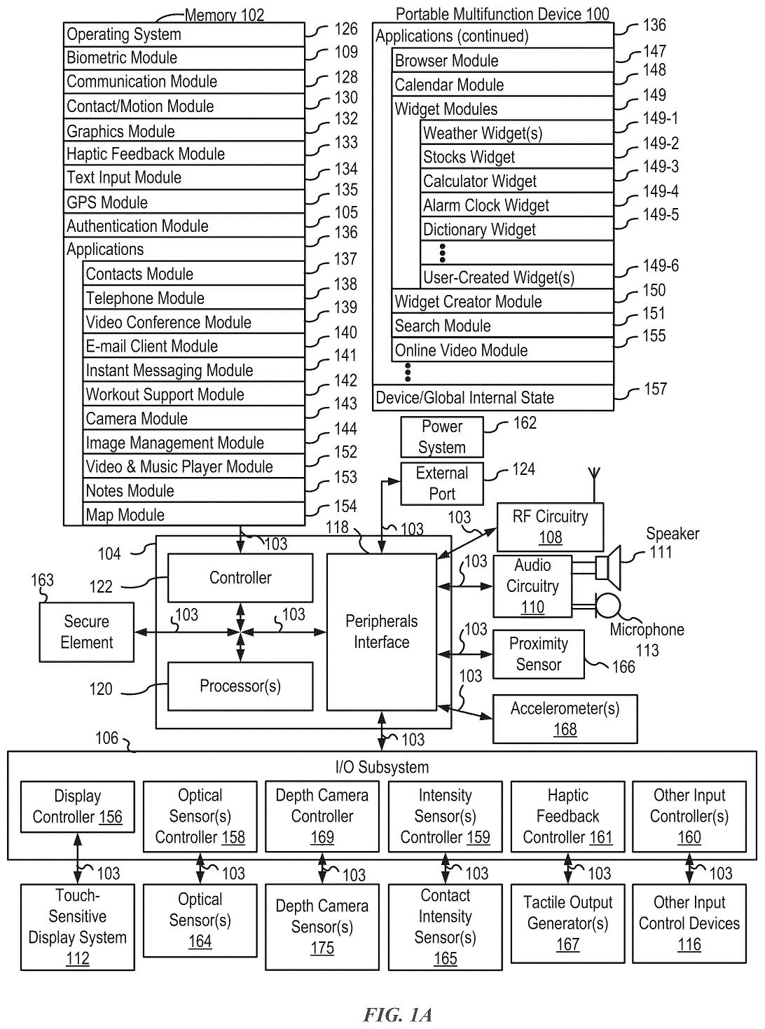

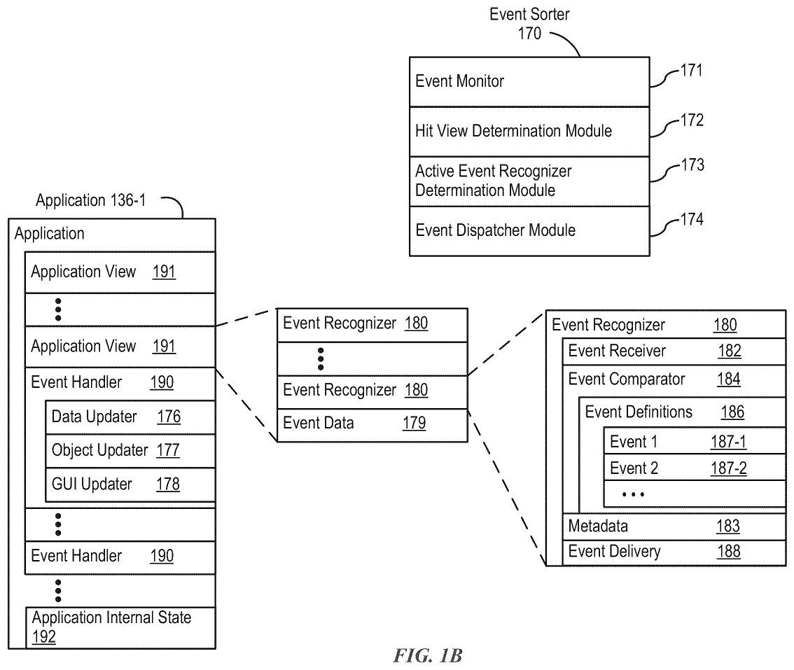

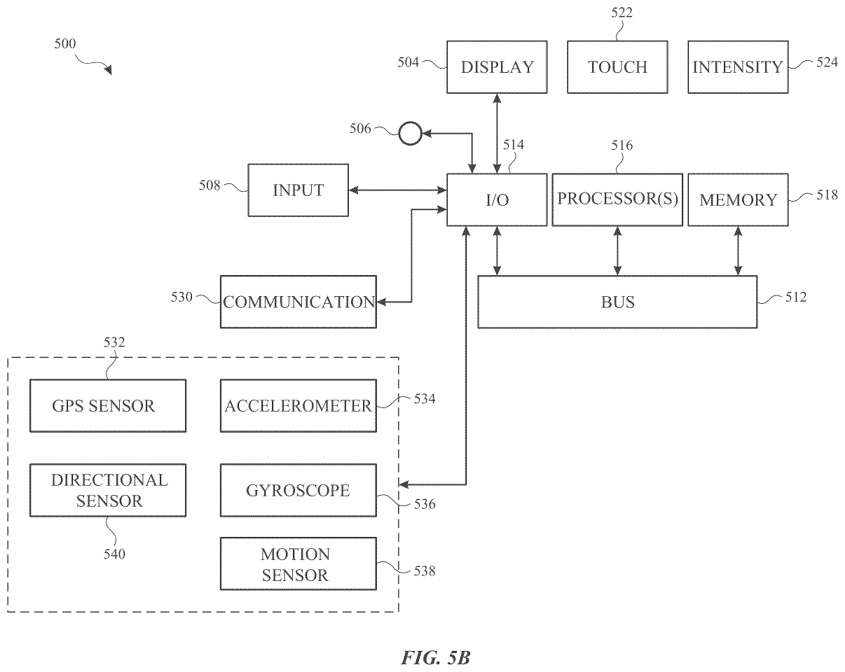

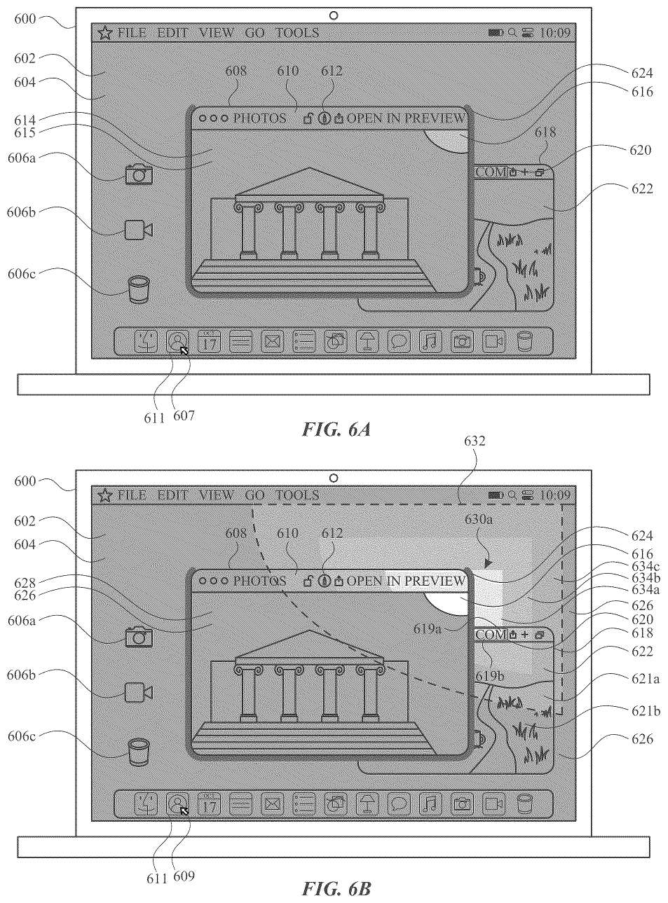

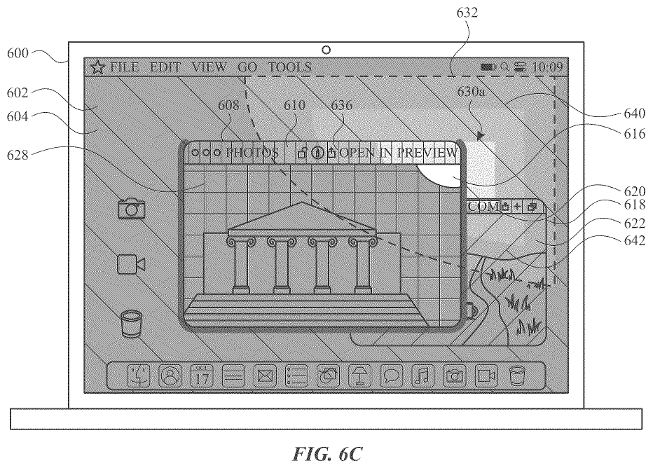

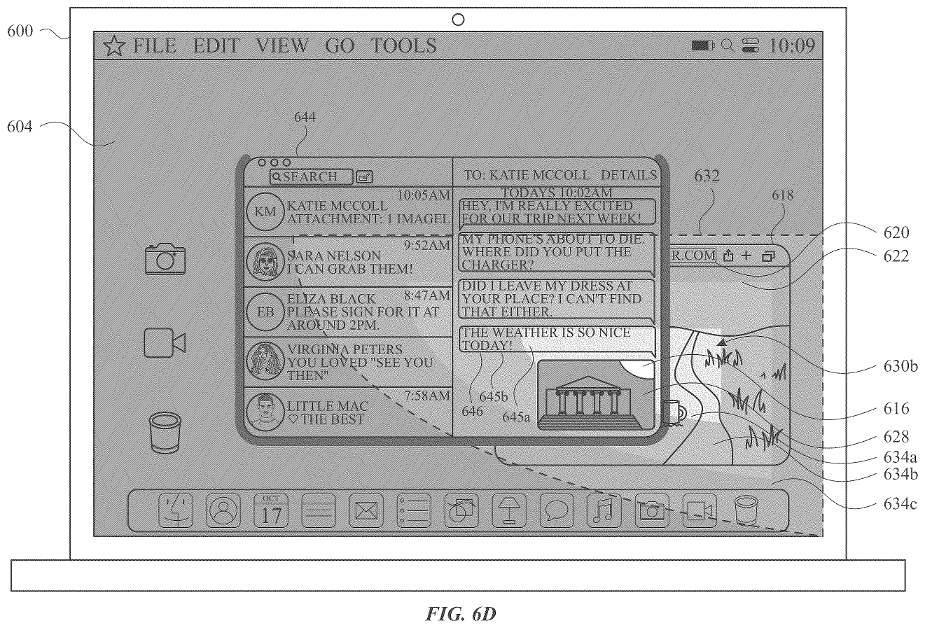

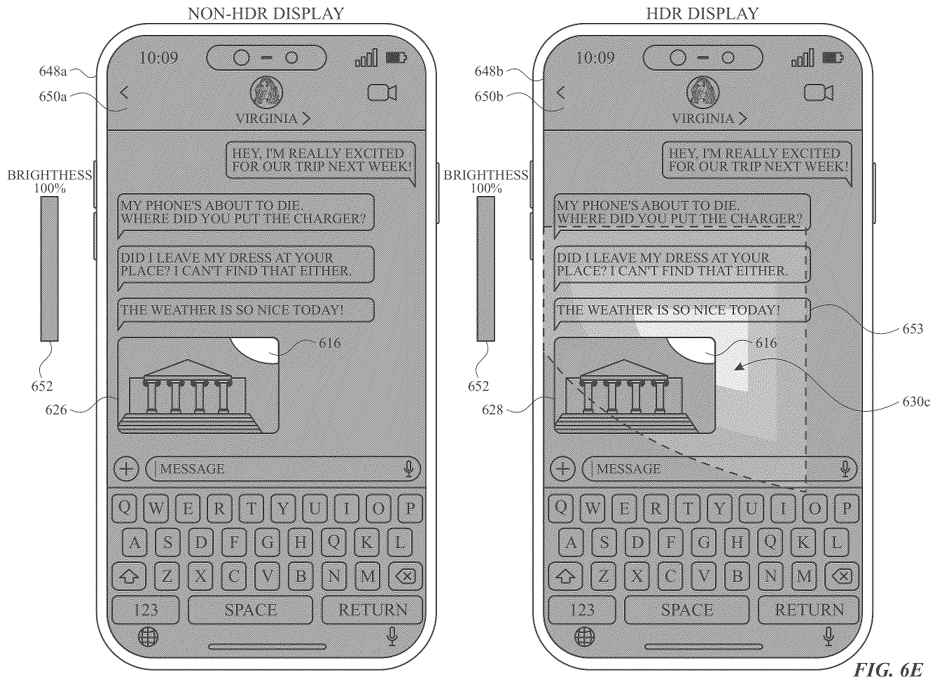

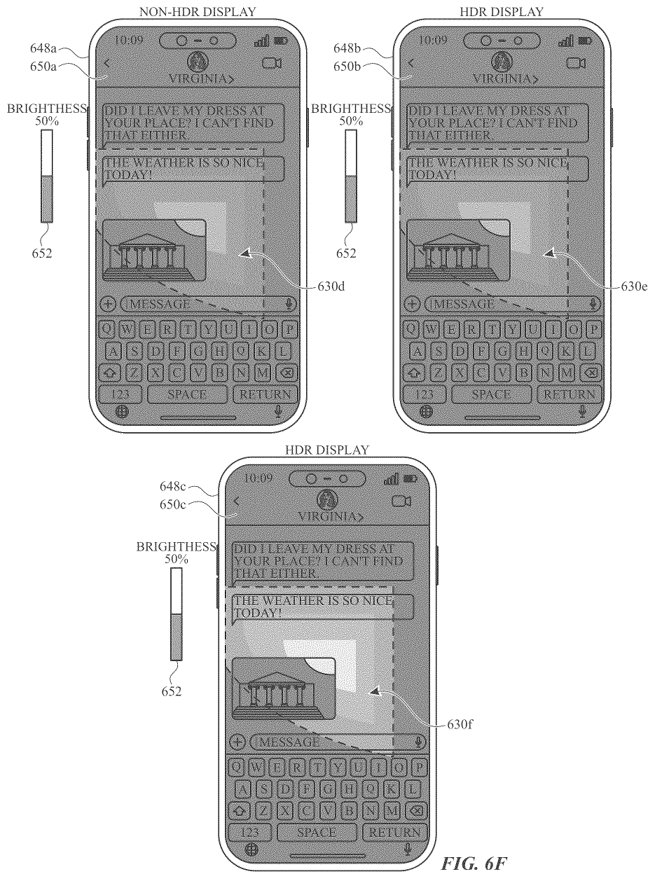

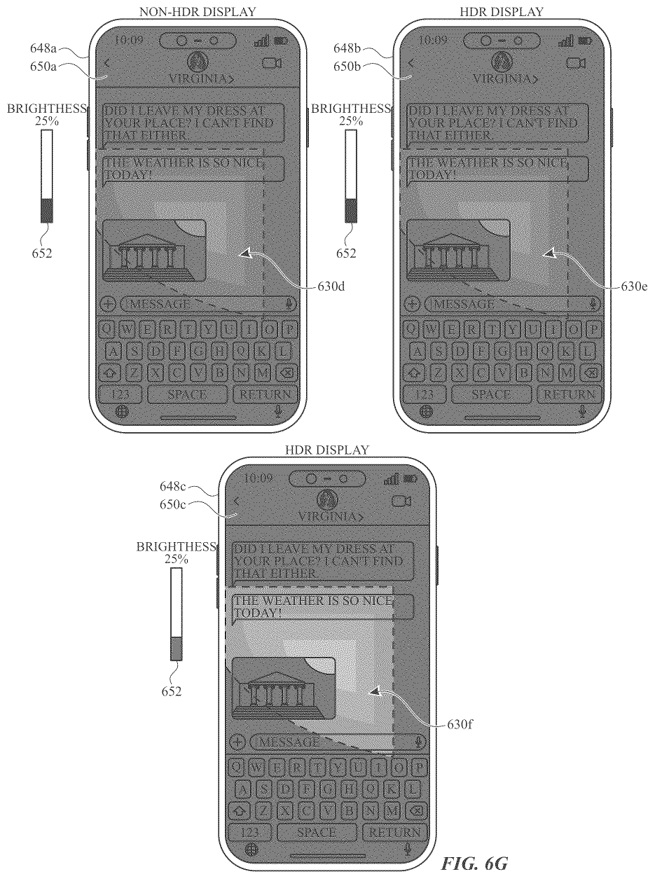

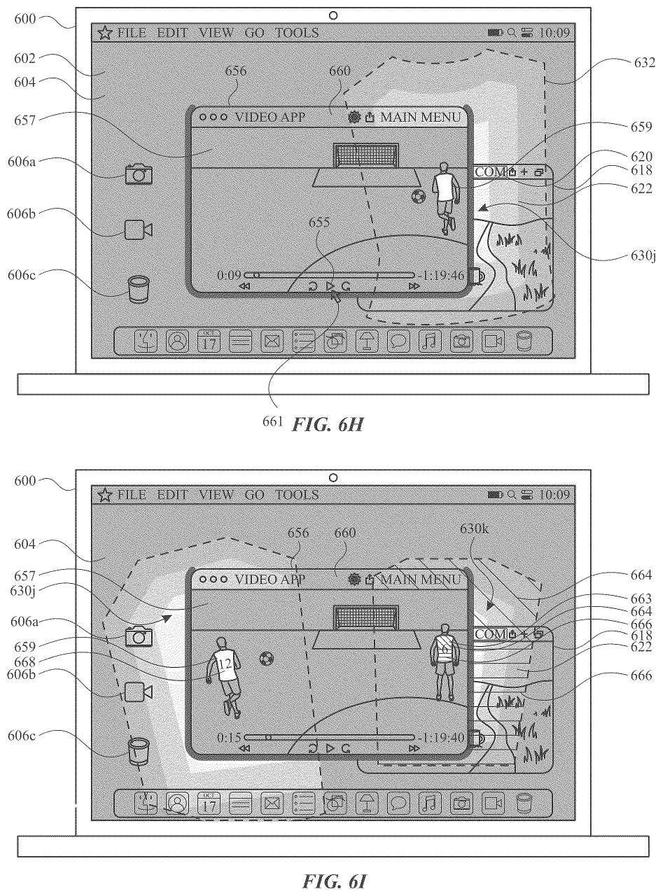

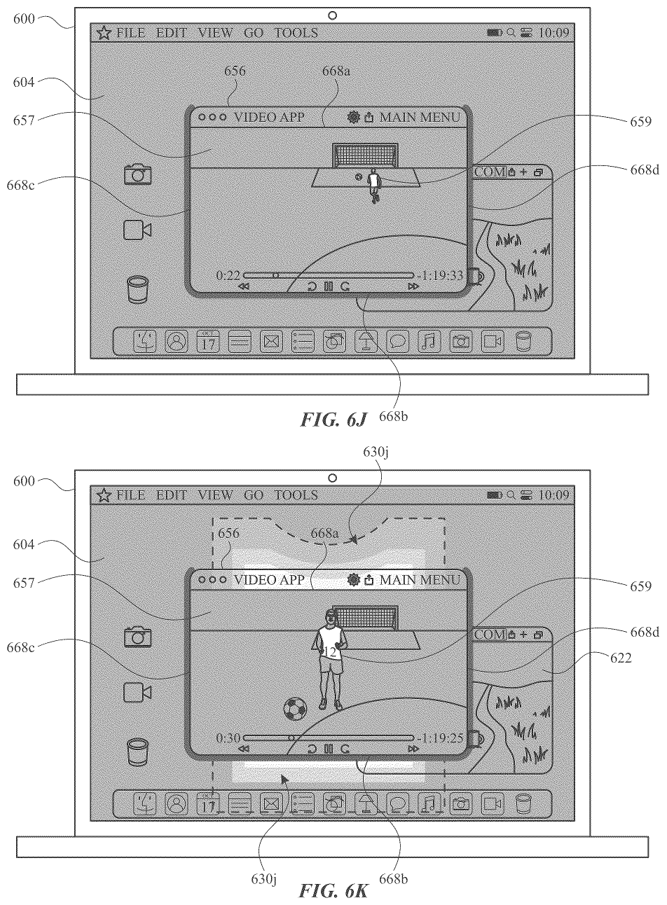

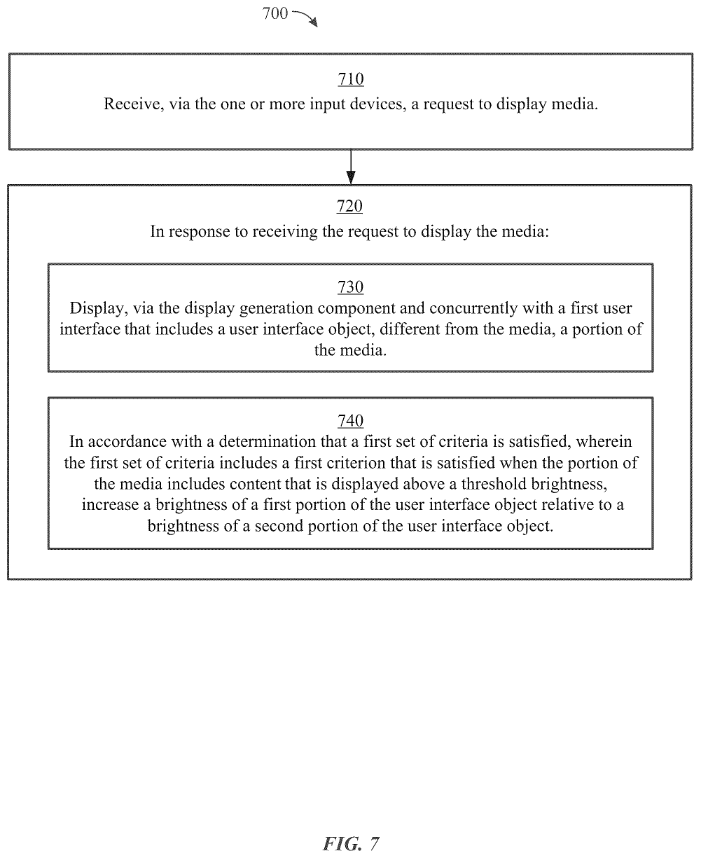

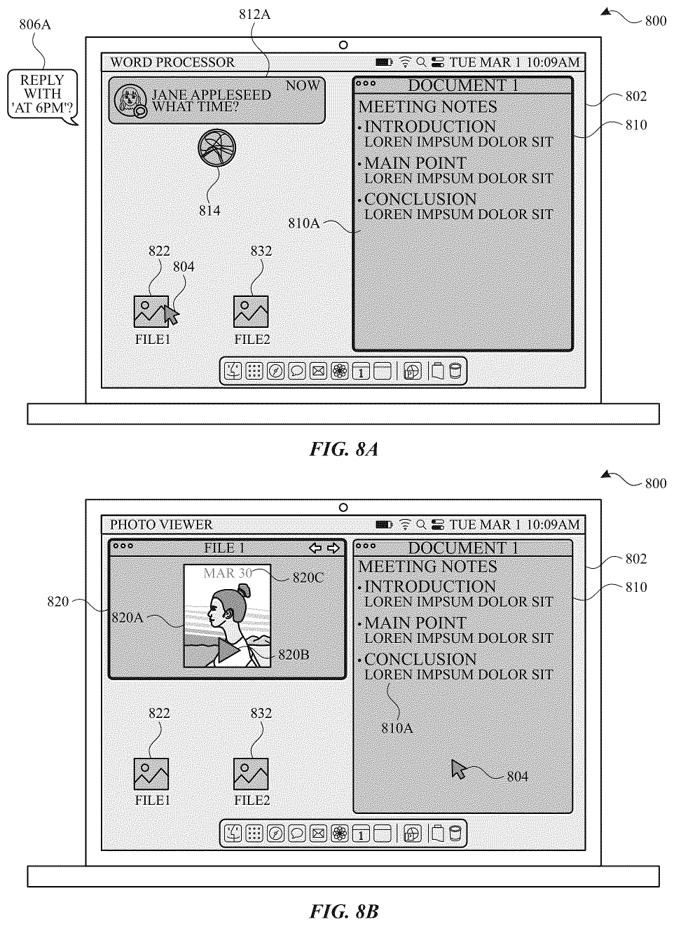

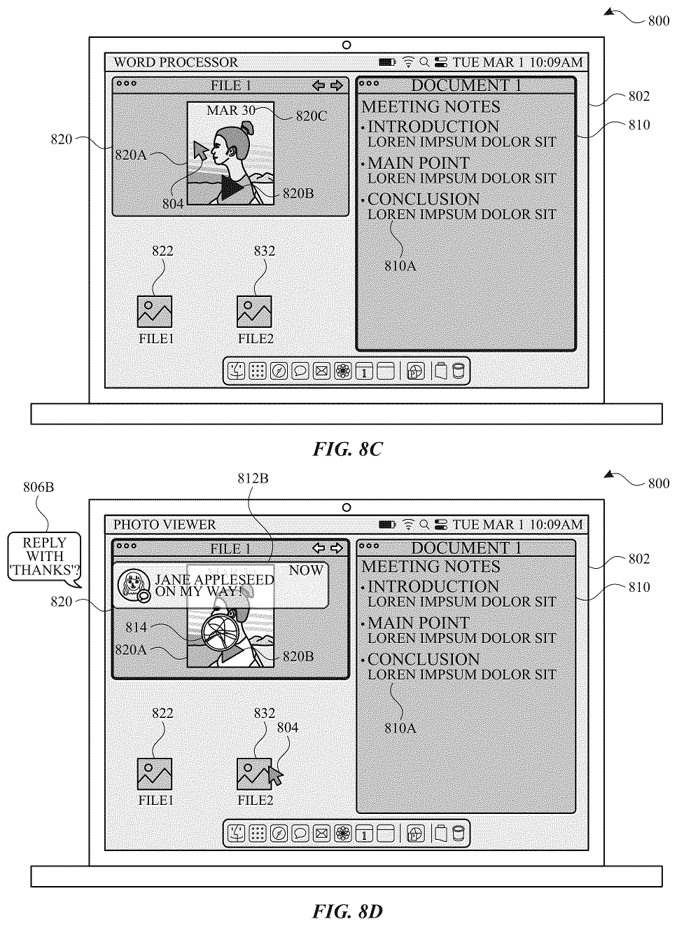

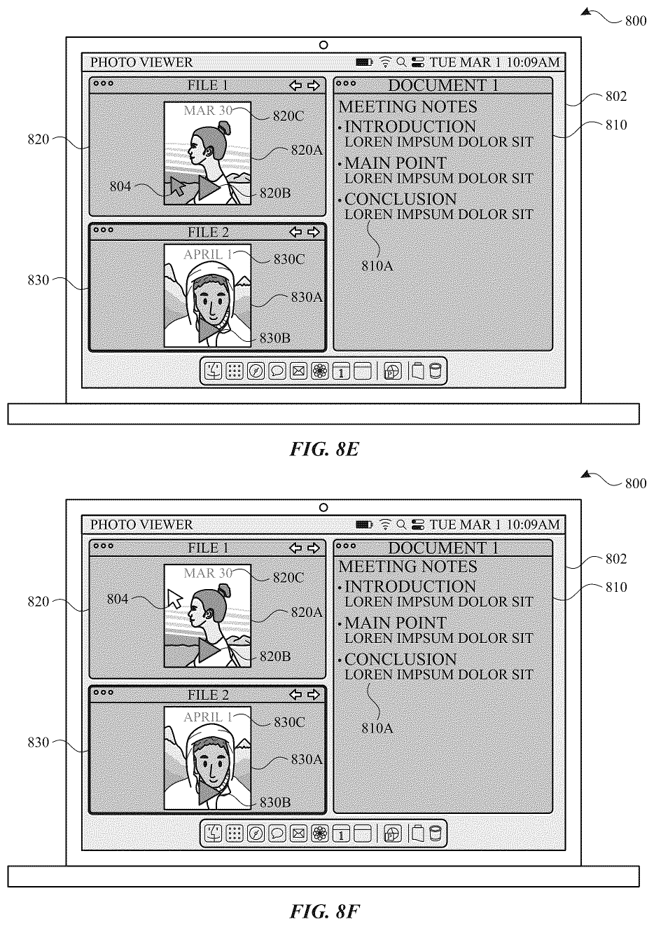

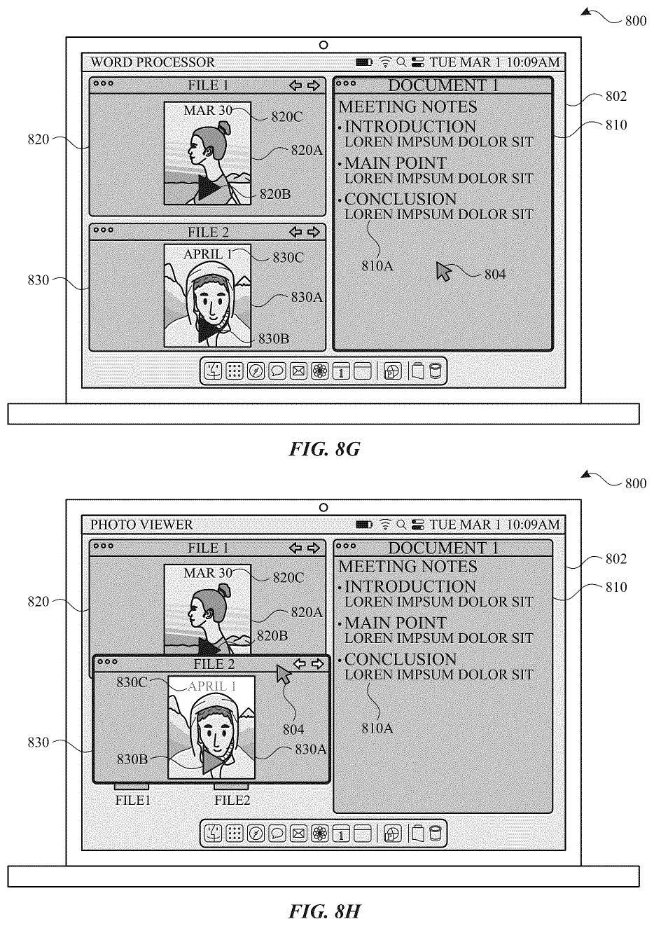

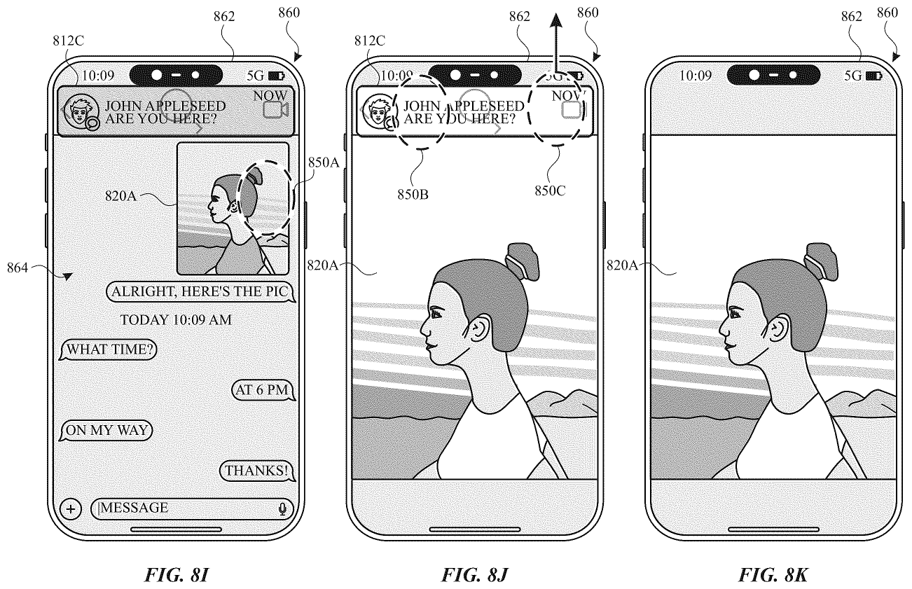

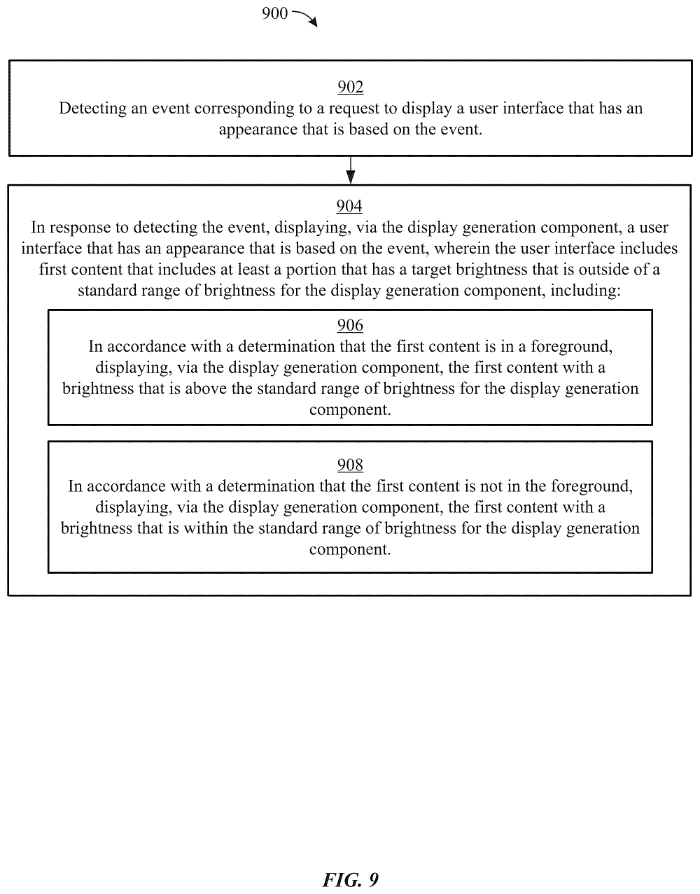

Below, FIGS. 1A-1B, 2, 3, 4A-4B, and 5A-5B provide a description of exemplary devices for performing the techniques for modifying the brightness of user interfaces. FIGS. 6A-6K illustrate exemplary user interfaces for modifying the brightness of user interface objects. FIG. 7 is a flow diagram illustrating methods of modifying the brightness of user interface objects in accordance with some embodiments. The user interfaces in FIGS. 6A-6K are used to illustrate the processes described below, including the processes in FIG. 7. FIGS. 8A-8K illustrate example user interfaces for modifying the brightness of user interface objects, in accordance with some embodiments. FIG. 9 is a flow diagram illustrating a method for modifying the brightness of user interface objects, in accordance with some embodiments. The user interfaces in FIGS. 8A-8K are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improve user interaction with user interface objects that are displayed near bright media content, and/or additional techniques. These techniques also reduce power usage and improve battery life of the device by enabling the user to use the device more quickly and efficiently. Additionally, the present technique prevents or reduces the need to keep the whole display in an HDR range, which would use significantly more power and have the potential to increase burn in or otherwise increase wear and tear on the display and decrease the lifespan of the display. Conditionally displaying HDR content and increasing the brightness of only portions of the display thus reduces power usage and avoids issues with burn in and wearing out the display in other ways.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

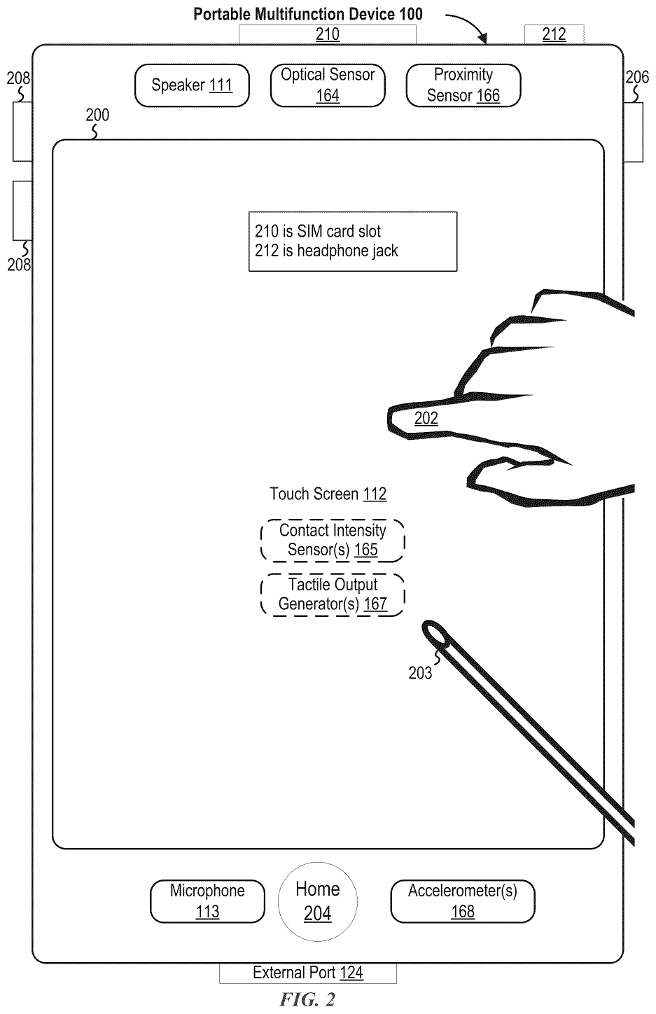

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

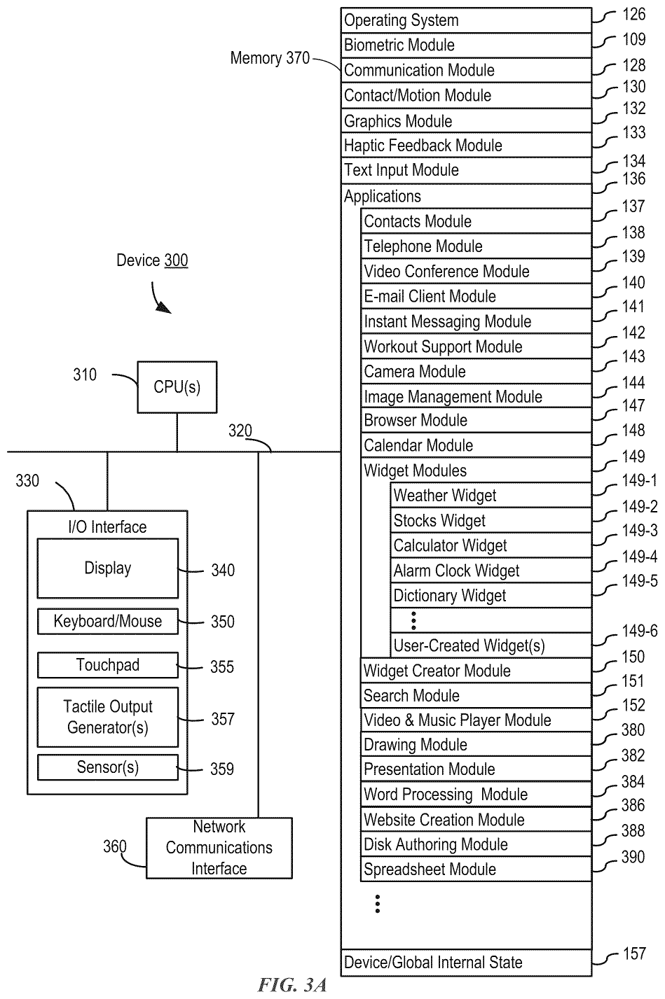

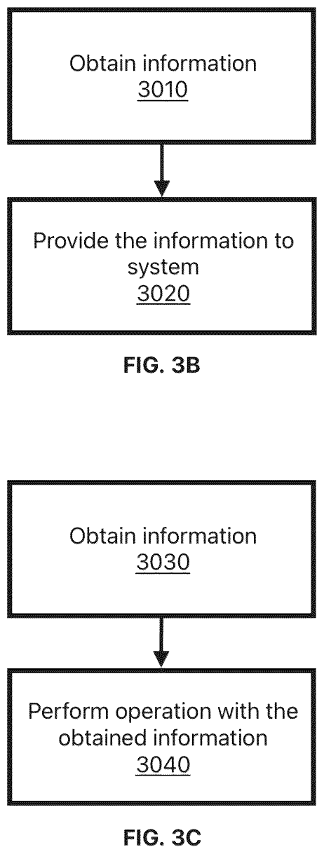

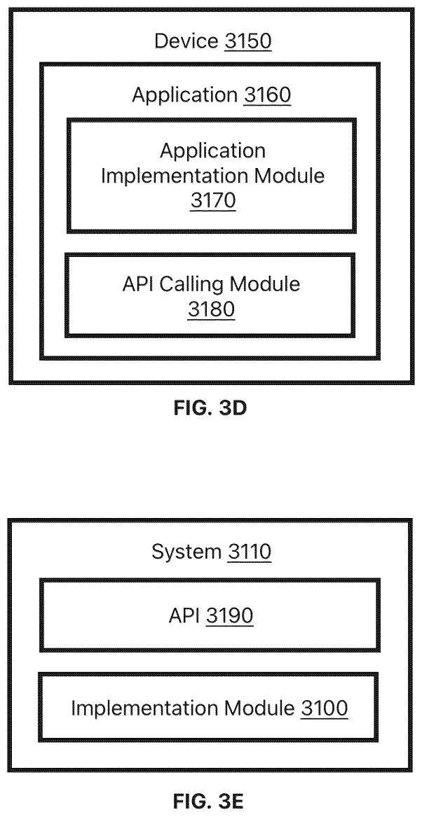

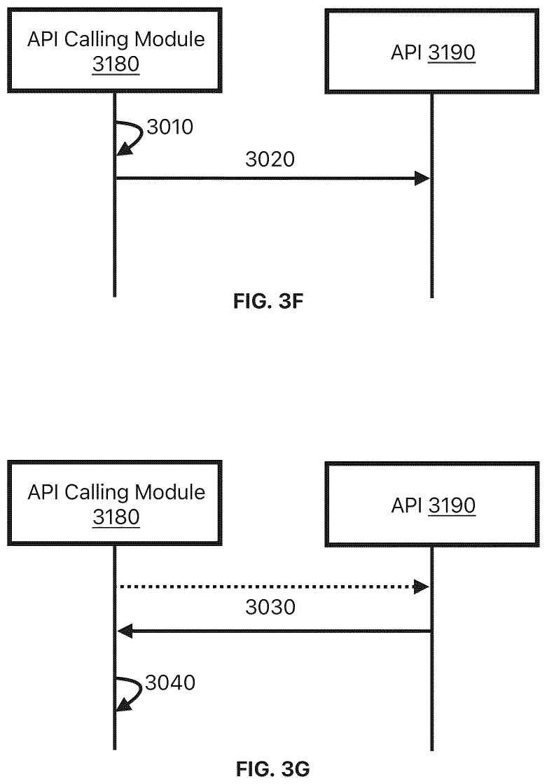

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

(1) In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 and/or 900 (FIGS. 7 and/or 9) by calling an application programming interface (API) provided by the system process using one or more parameters.

(1) In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

(2) In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

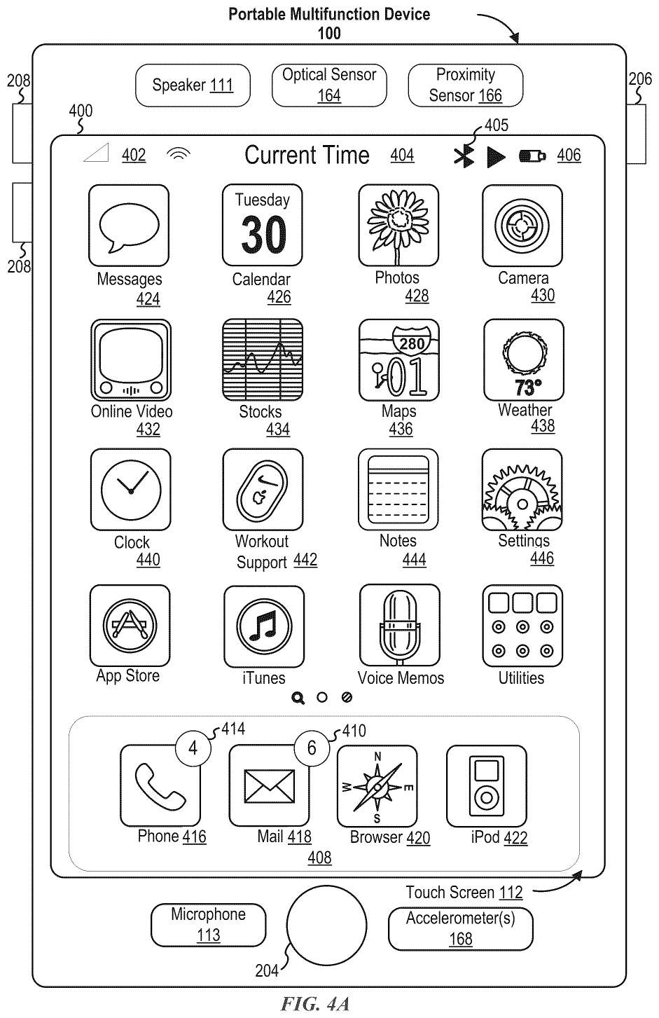

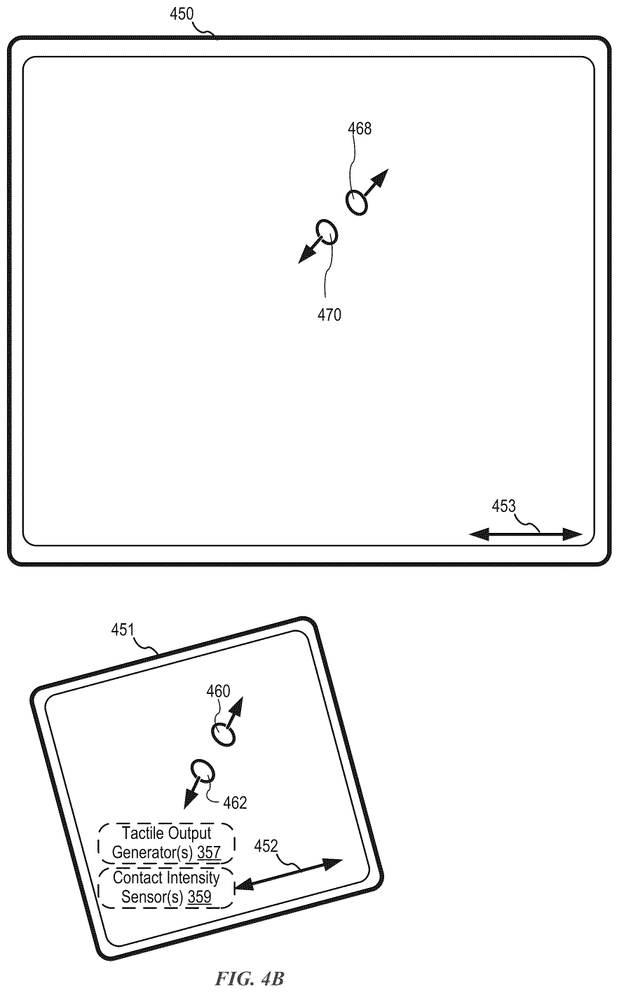

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

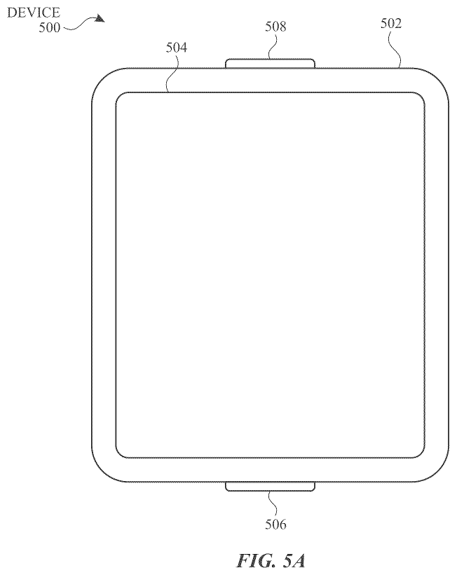

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to touch screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6K illustrate exemplary user interfaces for modifying the brightness of user interface objects, in accordance with some embodiments. The user interfaces in these figures are used to illustrate the processes described below, including the processes in FIG. 7.

At FIG. 6A, device 600 displays, on display 602, system user interface 604. System user interface 604 is depicted with various levels of gray shading (e.g., gray shading 615) to illustrate the different levels of brightness of display 602. As described herein, device 600 increases the brightness of particular content based on specific conditions being met. As such, while system user interface 604 is depicted as having gray shading 615, the colors of system user interface otherwise appear normal (e.g., the color white appears white). In some embodiments, the areas shown in gray in FIG. 6A are a respective color (e.g., red, blue, green, and/or white) having a respective brightness and the corresponding areas shown in white or light gray shading of FIG. 6B have a brightness that is brighter than the respective brightness of the respective color in FIG. 6A. System user interface 604 includes application icons 606a-606c that, when selected, cause device 600 to display various application user interfaces. In some embodiments, system user interface 604 includes content, such as text and/or images. In some embodiments, device 600 includes one or more features of devices 100, 300, and/or 500.

At FIG. 6A, in some embodiments, display 602 is a high dynamic range (HDR) display (or, optionally, is not an HDR display). In some embodiments, display 602 is a display that has a dynamic range that is wider than a standard dynamic range (SDR) display. In some embodiments, a dynamic range is the range of brightness (e.g., a range between the brightest level to the darkest level) and/or colors (e.g., a range and/or variation in colors). When referring to a display, in some embodiments, a dynamic range is a range of brightness and/or a range of colors that the display can display (e.g., produce). In some embodiments, an HDR display can display a range of brightness from 0.05 nits (e.g., cd/m²) to 1,000 nits (e.g., cd/m²). In some embodiments, an HDR display includes a range of brightness from 0.0005 nits (e.g., cd/m²) to 540 nits (e.g., cd/m²). In some embodiments, an HDR display is capable of displaying a brightness of at least 1,000 nits (or, optionally, a range of 1,000 nits to 4,000 nits). In some embodiments, a non-HDR display can display a maximum brightness that is less than a maximum brightness of an HDR display. In some embodiments, a non-HDR display can display a maximum brightness of less than 1,000 nits (or, optionally, a maximum brightness of 100 nits).

At FIG. 6A, in some embodiments, when referring to media (e.g., a photo and/or a video), a dynamic range is the range of brightness (e.g., a range between the brightest level to the darkest level) and/or colors (e.g., a range and/or variation in colors) included in the media. In some embodiments, non-HDR media includes data that initiates the display (e.g., via a display) of media having a maximum brightness that is less than a maximum brightness of media that is initiated by data included in HDR media. In some embodiments, an HDR image (and/or video) combines two separate images that are captured with two different exposure values into a single image. In such embodiments, one image (and/or frame of a video) that is captured with one exposure value is combined with another image (and/or frame of the video) that is captured at a different exposure value such that it produces a single image (and/or single frame of a video) that has a dynamic range that is higher than a dynamic range than the dynamic range of any one specific image that is being combined (e.g., the dynamic range of the combined image is higher than the particular dynamic range of each individual image being combined). In some embodiments, HDR media (or, optionally, an HDR display) satisfies the criteria defined by universal HDR standards, including HDR10, HDR10+, Advanced HDR, and/or Dolby Vision.

At FIG. 6A, device 600 detects input 607 (e.g., a mouse click, a tap input, and/or an air gesture) directed at photo viewing application icon 611 and, in response, displays non-HDR image 614 and photo viewing application user interface 608. Non-HDR image 614 includes an image of sun 616. Sun 616 is depicted as having a lighter shade of gray relative to gray shading 615 to illustrate a brightness of sun 616 is a brighter than other portions of non-HDR image 614. While sun 616 is brighter than other portions of non-HDR image 614, the brightness of sun 616 is not within an HDR range. As such, there is no glow displayed in FIG. 6A. In some embodiments, while gray shading 615 is depicted as being generally uniform throughout non-HDR image 614 (and/or other user interfaces), the brightness is optionally different (e.g., varies throughout non-HDR image 614). In some embodiments, detecting the request to display non-HDR image 614 includes an input to open a photo application that includes non-HDR image 614, an input to replace an image with non-HDR image 614, and/or an input to scroll through a photo library to display non-HDR image 614. At FIG. 6A, photo viewing application user interface 608 includes photo editing button 612 that, when selected, edits (e.g., crop, rotate, and/or alter) non-HDR image 614.

At FIG. 6A, device 600 is also displaying web-browser user interface 618. Web-browser user interface 618 includes text input field 620 and web content 622. Text input field 620 is optionally used for receiving text input to search for a website. As depicted, web content 622 includes an image. In some embodiments, web content 622 includes text, videos, and/or selectable user interface objects, such as buttons and/or drop-down menus. In some embodiments, web content 622 includes an HDR image.

At FIG. 6A, device 600 displays shadow 624. Shadow 624 is a simulated shadow that is displayed along an edge (e.g., top, bottom, left, and/or right) of photo viewing application user interface 608. Shadow 624 is displayed with a gray shading that is optionally darker than the gray shading of other portions of system user interface 604 (e.g., non-glow portion 626), photo viewing application user interface 608, and/or web-browser user interface 618 to illustrate the shadow being less bright (e.g., darker).

At FIG. 6B, device 600 detects input 609 (e.g., a mouse click, a tap input, and/or an air gesture) directed at photo viewing application icon 611 and, in response, device 600 displays HDR image 628 (e.g., an HDR version of non-HDR image 614). HDR image 628 includes sun 616. Sun 616 is illustrated as having little (or, optionally, no) gray shading to depict that the image of sun 616 is brighter than other portions of HDR image 628 and/or non-glow portion 626. Further, the image of sun 616 in FIG. 6B is illustrated as having little (or, optionally, no) shading to depict that the brightness of sun 616 in FIG. 6B is brighter relative to the brightness of sun 616 in FIG. 6A. In some embodiments, the brightness of sun 616 in FIG. 6B is brighter relative to the brightness of sun 616 in FIG. 6A because HDR image 628 has a wider dynamic range than non-HDR image 614. In some embodiments, at least a portion of non-glow portion 626 in FIG. 6B (e.g., an area outside of HDR image 628 where glow 630a is not displayed) has a brightness level that is the same brightness level of at least a portion of gray shading 615 (e.g., an area outside of non-HDR image 614) in FIG. 6A. In some embodiments, device 600 displays HDR image 628 in response to detecting a request to display HDR image 628. In some embodiments, detecting the request to display HDR image 628 includes an input to open a photo application that includes HDR image 628, an input to replace an image with HDR image 628, and/or an input to scroll through a photo library to display HDR image 628.

At FIG. 6B, device 600 displays glow 630a based on HDR image 628 having bright content. For example, device 600 detects that the brightness of sun 616 is a particular level of brightness (e.g., above a threshold brightness and/or within an HDR brightness range) and, in response, displays glow 630a on nearby content. In some embodiments, glow 630a alters the visual appearance of nearby content so that it appears brighter. In some embodiments, without glow 630a, the content would appear dark or dim based on HDR image 628 including sun 616. Glow 630a is illustrated as having a gradient of gray shading. The gradient is depicted with brightness portions 634a, 634b, and 634c, where each portion has a different amount of gray shading to depict different levels of brightness. For example, little to no gray shading depicts a higher level of brightness, while a greater amount of gray shading depicts a lower level of brightness. As such, brightness portion 634a has a higher level of brightness than the brightness levels in brightness portions 634b and 634c. Similarly, brightness portion 634b has a higher level of brightness than the brightness level of brightness portion 634c. Continuing, brightness portion 634c optionally has a higher level of brightness than the brightness levels of non-glow portion 626. While glow 630a is illustrated as having three distinct brightness portions for illustrative purposes, in some embodiments, the brightness of glow 630a gradually changes (e.g., is a smooth gradient).

At FIG. 6B, the brightness of glow 630a is based on the brightness of sun 616. In some embodiments, glow 630a is based on increasing an existing brightness of nearby content by an amount that is proportional to (e.g., 100%, 75%, 50%, and/or 25%) the brightness of sun 616.

At FIG. 6B, the brightness of glow 630a is brightest in areas closest to sun 616. The brightness of glow 630a then decreases in brightness as glow 630a extends away from sun 616. Glow 630a ends at boundary 632. It should be understood that the line for boundary 632 is not displayed by device 600 but is provided for illustrative purposes to depict an end of glow 630a.

At FIG. 6B, glow 630a is displayed on content adjacent to sun 616. Glow 630a is displayed on content within the user interface that includes HDR image 628 and/or displayed on content outside of the user interface that includes HDR image 628. For example, glow 630a is applied to window banner 610 of photo viewing application user interface 608, brightening photo edit button 612 (e.g., photo edit button 612 of FIG. 6B is brighter than photo edit button 612 of FIG. 6A). For another example, glow 630a is applied to web-browser user interface 618, brightening web content 622 (e.g., web-browser user interface 618 of FIG. 6B is brighter than web-browser user interface 618 of FIG. 6A). For another example, glow 630a is not applied to HDR image 628, as illustrated by non-glow portion 626 of HDR image 628 being the same shade as non-glow portion 626 of non-HDR image 614. In some embodiments, glow 630a is applied to HDR image 628.

At FIG. 6B, the brightest portion of glow 630a (e.g., brightness portion 634a) is located closest to sun 616, while the less bright portion (e.g., brightness portion 634c) is located furthest from sun 616. As such, user interface objects closer to sun 616 (e.g., text input field 620) have a greater increase in brightness than user interface objects further from sun 616 (e.g., web content 622).

At FIG. 6B, one portion of a user interface object has a different level of brightness than another portion of the user interface object. For example, first portion 619a of text input field 620 is brighter than second portion 619b of text input field 620 (e.g., as illustrated by first portion 619a being located in brightness portion 634a and second portion 619b being located in brightness portion 634b). As another example, first portion 621a of web content 622 is brighter than second portion 621b of web content 622 (e.g., as illustrated by first portion 621a being located in brightness portion 634c and second portion 621b of web content 622 being located in non-glow portion 626).

At FIG. 6B, a characteristic of glow 630a is based on a characteristic of sun 616. For example, the location, shape, orientation, and/or size of glow 630a is based on the location, shape, orientation, and/or size of sun 616. As illustrated, the location of glow 630a is centered relative to the location of sun 616. In some embodiments, a center point of glow 630a is within a threshold distance (e.g., 0 inch, 0.1 inch, 0.5 inches, and/or 1 inch) of a center point of sun 616. The shape of glow 630a is depicted by the shape of boundary 632 and/or the shape of brightness portions 630a-630c. For example, as depicted, boundary 632 includes straight and curved lines that make a shape that corresponds to the shape of the straight and curved edges of sun 616. In some embodiments, glow 630a is based on blurring and/or feathering a portion of the shape and/or edges of sun 616. In some embodiments, the shape of glow 630a is not based on the shape of sun 616. For example, in such embodiments, the shape of glow 630a is predetermined shape (e.g., a square, a rectangle, and/or a circle). In some embodiments, the shapes of brightness portions 630a-630c would be the same if brightness portions 630a-630c were also displayed on HDR image 628.

At FIG. 6B, the size of glow 630a is based on enlarging the size of sun 616. As depicted, glow 630a is larger than the size of sun 616. In some embodiments, the size of glow 630a is based on enlarging the size of sun 616 by a predetermined amount (e.g., the size of glow 630a is 2, 5, and/or 10 times the size of the size of sun 616). As described in greater detail herein, in some embodiments, one or more colors (and/or spatial coloring) of glow 630a is based on one or more colors (and/or spatial coloring) of sun 616.

At FIG. 6B, device 600 concurrently displays shadow 624 with glow 630a. As described with respect to FIG. 6A, shadow 624 is a simulated shadow that is displayed between user interfaces. As such, shadow 624 is not caused by glow 630a. In some embodiments, glow 630a does not cause any shadow to be displayed. Further, in some embodiments, shadow 624 is displayed before and/or after displayed glow 630a. In some embodiments, glow 630a increases the brightness of a portion of shadow 624 that is within boundary 632 of glow 630a by making the portion of shadow 624 that is within boundary 632 of glow 630a appear brighter than a portion of shadow 624 that is not within boundary 632 of glow 630a. In some embodiments, glow 630a does not increase the brightness of a portion of shadow 624 that lies within boundary 632 of glow 630a.

At FIG. 6B, a brightness of glow 630a is based on whether bright media content is in a foreground user interface or a background user interface. As illustrated, photo viewing application user interface 608 is in a foreground and web-browser user interface 618 is in the background. HDR image 628 of photo viewing application user interface 608 is prioritized and/or displayed over web content 622 of web-browser user interface 618. In some embodiments, the brightness of glow 630a is based on whether sun 616 is in a foreground user interface or background user interface. In such embodiments, if sun 616 is in the foreground user interface, device 600 displays a brighter glow relative to the brightness of a glow caused by sun 616 when sun 616 is displayed in a background user interface. In some embodiments, web-browser user interface 618 is the foreground and photo viewing application user interface 608 is the background. In such embodiments, device 600 displays a glow for sun 616, but the glow has a different state. For example, in such embodiments, the glow that is displayed when photo viewing application user interface 608 is in the background is not as bright relative to glow 630a when photo viewing application user interface 608 is in the foreground.

At FIG. 6C, glow 630a increases the brightness of the colors of nearby content. For example, glow 630a increases the brightness of a color (and/or multiple colors), depicted with vertical hatching 636, of window banner 610 of photo viewing application user interface 608. As another example, glow 630a increases the brightness of a color (and/or multiple colors), depicted with diagonal hatching 640, of a portion of system user interface 604. As a further example, glow 630a increases the brightness of a color (and/or multiple colors), depicted with diagonal hatching 642, of web content 622 of web-browser user interface 618. As described in further detail herein, in some embodiments, the color of glow 630a is based on the color of sun 616. In such embodiments, the color of glow 630a alters the color of nearby content (e.g., the color of photo viewing application user interface 608, the color of system user interface 604, and/or the color of web content 622 of web-browser user interface 618).

At FIG. 6D, device 600 displays HDR image 628 in an application user interface that is different from photo viewing application user interface 608. As illustrated, glow 630b is still applied to nearby content while being displayed in a different user interface (e.g., text messaging application user interface 644). Glow 630a is similar to glow 630b but has a different state (e.g., smaller, different location, and/or different shape) based on the state of sun 616 in FIG. 6D. For example, glow 630b is applied to different content and/or different areas of display 602 of FIG. 6D as compared to the content and/or area of display 602 to which glow 630a is being applied in FIG. 6C (e.g., glow 630b has shifted down and does not cover as big of an area as compared to glow 630a).

At FIG. 6D, glow 630b is applied to content of the application causing the display of the image while not being applied to HDR image 628. For example, glow 630b is applied to the text of text message 646. As illustrated, first portion 645a of text message 646 is brighter than second portion 645b of text message 646 (e.g., as illustrated by first portion 645a being within brightness portion 634a and second portion 645b being within brightness portion 634b). Additionally, glow 630b is applied to content of other user interfaces and/or applications, such as web-browser user interface 618 and/or system user interface 604.

At FIG. 6E, device 648a and device 648b both display HDR image 628. Device 648a includes non-HDR display 650a that has brightness setting 652 set at 100%. Device 648b includes an HDR display 650b that has brightness setting 652 set at 100%. In some embodiments, brightness setting 652 is a brightness setting that is an adjustable setting. In some embodiments, brightness setting 652 is changed manually (e.g., based on input by a user of a device) or automatically (e.g., automatically by device 648a and/or device 648b). As illustrated, device 648a with non-HDR display 650a does not display a glow on nearby content. In some embodiments, device 648a does not display a glow because device 648a includes a non-HDR display and/or a brightness setting is set at a maximum brightness level (e.g., 100%).

Continuing, at FIG. 6E, device 648b with HDR display 650b displays glow 630c on nearby content (e.g., text message 653) while brightness setting 652 is set at 100%. Glow 630c is similar to glow 630a but has a different state. In some embodiments, device 648b displays glow 630c while brightness setting 652 is set at 100% because device 648b includes an HDR display. In some embodiments, device 648b with HDR display 650b displays a glow 630c regardless of a brightness setting. In some embodiments, device 648a and/or device 648b includes one or more features of devices 100, 300, and/or 500.

At FIG. 6F, brightness setting 652 has changed to be below 100%. As a result, device 468a displays glow 630d on nearby content. Glow 630d is similar to glow 630a but has a different state. As illustrated, brightness setting 652 of device 468a is set at 50%. In some embodiments, device 468a displays glow 630d when brightness setting 652 is less than a maximum brightness level setting (e.g., is less than 100%). Device 468b also displays glow 630e on nearby content while brightness setting 652 is at 50%. Glow 630e is similar to glow 630c of FIG. 6E (and/or glow 630a) but has a different state. For example, glow 630e of FIG. 6F is less bright than glow 630c of FIG. 6E because brightness setting 652 of FIG. 6F is less than brightness setting 652 of FIG. 6E.

At FIG. 6F, in some embodiments, a glow provided by a device having an HDR display is brighter than a glow provided by a device having a non-HDR display. For example, device 468c includes HDR display 650c. Device 468c displays glow 630f on nearby content while brightness setting 652 is at 50%. Glow 630f of device 468c with HDR display 650c is depicted with lighter gray shading relative to the gray shading of glow 630d of device 468a with non-HDR display 650a to illustrate that glow 630f is brighter than glow 630d.

At FIG. 6G, the brightness of glows 630d-632f is updated in response to detecting a change in brightness setting 652. For example, device 648a updates the brightness of glow 630d of FIG. 6G to be less bright than glow 630d in FIG. 6F in response to detecting brightness setting 652 changing from 50% to 25%. As another example, device 648b (and/or device 648c) updates the brightness of glow 630e (and/or 630f) of FIG. 6G to be less bright than glow 630e (and/or 630f) of FIG. 6F in response to detecting a change in brightness setting 652 from 50% to 25%.

At FIG. 6H, device 600 displays video application user interface 656. Video application user interface 656 includes HDR video 657 and window banner 660. Device 600 displays glow 630j on nearby content based on detecting a brightness of jersey 659 (e.g., an HDR portion). Glow 630j is similar to glow 630a (e.g., glow 630j includes boundary 632 and brightness portions 634a-634c) but has a different state. As illustrated, glow 630j is applied to a portion of window banner 660, a portion of system user interface 604, and a portion of web-browser user interface 618. Device 600 detects input 661 (e.g., tap, mouse click, and/or air gesture) directed at play button 655. In response to detecting input 661, device 600 plays HDR video 657.

At FIG. 6I, device 600 detects that jersey 659 (e.g., the HDR portion) has moved to a different location while HDR video 657 is being played. For example, jersey 659 is on the left side of HDR video 657 in FIG. 6I as opposed to being on the right side of HDR video 657 in FIG. 6H. At FIG. 6I, in response to detecting that jersey 659 has moved, device 600 updates the characteristics (e.g., location, shape, orientation, and/or size) of glow 630j. As illustrated, glow 630j of FIG. 6I is applied to a different area of display 602 and/or a different portion of system user interface 604 than glow 630j of FIG. 6H. For example, glow 630j of FIG. 6I is applied to application icons 606a-606c, whereas glow 630j of FIG. 6H is not applied to application icons 606a-606c. As a further example, glow 630j of FIG. 6I is not applied to web-browser user interface 618, whereas glow 630j of FIG. 6H is applied to web-browser user interface 618. As another example, glow 630j of FIG. 6I is applied to a different portion of window banner 610 as compared to the portion of window banner 610 being brightened by glow 630j of FIG. 6H.

At FIG. 6I, in some embodiments, device 600 detects a change in brightness of jersey 659 (e.g., the HDR portion). In such embodiments, in response to detecting the change in brightness of jersey 659 (e.g., the HDR portion), device 600 modifies the brightness of glow 630j. In some embodiments, glow 630j becomes brighter (or, optionally, less bright) if jersey 659 becomes brighter (or, optionally, less bright).

At FIG. 6I, device 600 detects that HDR video 657 includes additional bright content (e.g., additional HDR portions). For example, device 600 detects that jersey 663 is also being displayed. In response to detecting that jersey 663 is being displayed, device 600 displays glow 630k. Glow 630k is similar to glow 630a but has a different state. As illustrated, glow 630k does not overlap with glow 630j. In some embodiments, glow 630k does overlap with glow 630j (e.g., based on characteristics of jersey 659 and characteristics of jersey 663). In such embodiments, at least a portion (e.g., less than all) of glow 630j overlaps with a portion of glow 630k. In such embodiments, the overlapping portion includes a combination of a characteristic (e.g., color, shape, size, orientation and/or brightness) of glow 630j and a characteristic of glow 630k. In some embodiments, all portions of glow 630j overlap with a portion of glow 630k (or, optionally, all portions of glow 630k overlap with a portion of glow 630j).

At FIG. 6I, the color of glow 630k is based on the color of jersey 663. Jersey 663 includes one color that is depicted by diagonal hatching 664 and a different color that is depicted by horizontal hatching 666. As illustrated, glow 630k includes the color depicted by diagonal hatching 664 and the color depicted by diagonal hatching 664. The characteristics (e.g., location, size, orientation, and/or shape) of the colors included in glow 630k are based on the characteristics of the colors included in jersey 663. For example, the position of diagonal hatching 664 of jersey 663 is located above the position of horizontal hatching 666 of jersey 663. As such, the position of diagonal hatching 664 of glow 630k is located above the position of horizontal hatching 666 of glow 630. In some embodiments, the color of glow 630k (but not the color of glow 630j) is applied to the color of web content 622 of web-browser user interface 618. In such embodiments, the color(s) of web content 622 appears differently from the original color of web content based on displaying the color(s) of glow 630k. In some embodiments, the color of glow 630k is different from the color of glow 630j.

At FIG. 6J, device 600 stops displaying glow 630j. In particular, device 600 detects a change in characteristics (e.g., location, shape, orientation, and/or size) of jersey 659 (e.g., an HDR portion) while playing HDR video 657. For example, jersey 659 is smaller and located near the center of HDR video 657. In response to detecting the change in characteristics of jersey 659, device 600 stops displaying glow 630j of FIG. 6H. In some embodiments, device 600 stops displaying glow 630j because the characteristics of jersey 659 does not cause a glow to be displayed beyond edge 668 of HDR video 657. For example, when device 600 generates a glow based on the location, size, orientation, and/or shape of jersey 659, the resulting glow does not extend beyond edges 668a-668c. In response to detecting that the glow does not extend beyond edge 668, device 600 does not display glow 630j. As illustrated, no glow is depicted in FIG. 6J even though HDR video 657 includes bright content (e.g., jersey 659 and/or an HDR portion). Further, device 600 of FIG. 6J detects that jersey 663 is no longer being displayed and, in response, does not display glow 630k.

At FIG. 6K, device 600 detects a change in characteristics (e.g., location, shape, orientation, and/or size) of jersey 659 (e.g., an HDR portion) while playing HDR video 657. For example, the size of jersey 659 of FIG. 6K is larger as compared to the size of jersey 659 of FIG. 6J. In response to detecting the change in characteristics of jersey 659 (e.g., an HDR portion), device 600 displays (e.g., re-displays) glow 630j of FIG. 6H. As illustrated in FIG. 6K, glow 630j extends beyond top edge 668a and bottom edge 668b of HDR video 657. Glow 630j does not extend beyond left edge 668c and right edge 668d.

FIG. 7 is a flow diagram illustrating a method for modifying the brightness of user interface objects using a computer system in accordance with some embodiments. Method 700 is performed at a computer system (e.g., 100, 300, 500, 600, and/or 648a-648c) (e.g., a smartphone, a tablet computer, a laptop computer, a desktop computer, and/or a head mounted device (e.g., a head mounted augmented reality and/or extended reality device)) that is in communication with a display generation component (e.g., 602 and/or 650a-650c) (e.g., a display controller, a touch-sensitive display system, a monitor, and/or a head mounted display system) and one or more input devices (e.g., a touch-sensitive surface, a keyboard, a controller, and/or a mouse). In some embodiments, the computer system (e.g., 600 and/or 648a-648c) is in communication with one or more cameras (e.g., an infrared camera, a depth camera, and/or a visible light camera). Some operations in method 700 are, optionally, combined, the orders of some operations are, optionally, changed, and some operations are, optionally, omitted.

As described below, method 700 provides an intuitive way for modifying the brightness of user interface objects. The method reduces the cognitive burden on a user to interact with user interface objects that are located near bright media content, thereby creating a more efficient human-machine interface. For battery-operated computing devices, enabling a user to interact with user interface objects faster and more efficiently conserves power and increases the time between battery charges.

The computer system (e.g., 600 and/or 648a-648c) receives (710) (e.g., while displaying a user interface object or while not displaying the user interface object), via the one or more input devices, a request (e.g., 607 and/or 609) to display media (e.g., 626, 657, and/or 661) (e.g., image data) (e.g., a photo and/or video).

In response to receiving the request (e.g., 607 and/or 609) to display the media (e.g., 626, 657, and/or 661) (720), the computer system (e.g., 600 and/or 648a-648c) displays (730), via display generation component (e.g., 602 and/or 650a-650c) and concurrently with a first user interface (e.g., an operating system user interface and/or an application user interface other than (or, optionally, the same as) a user interface of the application displaying the media) that includes a user interface object (e.g., 606a-606c, 612, 620, 622, and/or 646), different from the media (e.g., of a second user interface (e.g., the same as or different from the first user interface)) (e.g., the user interface object is displayed at a location that is outside of (e.g., partially surrounding, adjacent to, does not overlap with, and/or is within a threshold distance from) a display location of the media), a portion of (e.g., all of or less than all of) the media (optionally, the first user interface corresponds to a different application from the application that includes the media). In some embodiments, the user interface object is an application icon, a text message, a text input field, a virtual button of a software keyboard, and/or content (e.g., text or images) of an application user interface that is different from (or, optionally, the same as) an application user interface of the application displaying the media. In some embodiments, the user interface object is an application icon, a text message, a text input field, a virtual button of a software keyboard, and/or content (e.g., text or images) of an operating system user interface that is different from the application user interface of the application displaying the media. In some embodiments, the user interface object is a selectable user interface object that, when selected, causes the computer system to perform a function (e.g., open an application and/or edit content). In some embodiments, the user interface object is not a selectable user interface object.

In accordance with a determination that a first set of criteria is satisfied (740), wherein the first set of criteria includes a first criterion that is satisfied when the portion of the media includes content (e.g., 616) (e.g., high-dynamic-range (HDR) content, content having a dynamic range that is different from (e.g., less than or more than) HDR content, and/or content having a dynamic range that is different from (e.g., less than or more than) standard-dynamic-range (SDR) content) that is displayed above a threshold brightness (e.g., is above a predefined brightness threshold and/or has a respective brightness level), increasing a brightness of a first portion (e.g., 619a, 621a, and/or 645a) of the user interface object relative to a brightness of a second portion (e.g., 619b, 621b, and/or 645b) of the user interface object (e.g., displaying a glow effect that brightens portions of the user interface near a portion of the media that includes content that is displayed above the brightness threshold). In some embodiments, in accordance with the determination that the first set of criteria is satisfied, the computer system (e.g., 600, and/or 648a-648c) forgoes increasing the brightness of a third portion of the user interface object (e.g., the third portion of the user interface object is displayed at a regular brightness level because the glow effect is not displayed). Increasing a brightness of a first portion of the user interface object relative to a brightness of a second portion of the user interface object when a first set of criteria is satisfied, where the first set of criteria includes a criterion that is satisfied when the portion of the media includes content that is displayed above a threshold brightness, performs an operation when a set of conditions has been met without requiring further user input, improves how user interface objects are displayed when bright content is also displayed (e.g., user interface objects near the bright media content do not appear as dim or dull as compared to the bright media content), and prevents keeping the whole display in an HDR range, which would use significantly more power and have the potential to increase burn in or otherwise increase wear and tear on the display and decrease the lifespan of the display. Conditionally displaying HDR content and increasing the brightness of only portions of the display thus reduces power usage and avoids issues with burn in and wearing out the display in other ways.

In some embodiments, increasing the brightness of the first portion of the user interface object (e.g., 619a, 621a, and/or 645a) relative to the brightness of the second portion of the user interface object (e.g., 619b, 621b, and/or 645b) includes in accordance with a determination that the content that is displayed above the threshold brightness is displayed at a first location (e.g., the location of 616 in FIG. 6B), the first portion of the user interface object (e.g., that is brightened relative to the second portion of the user interface object) corresponds to a first area of the user interface object (e.g., the area of glow 630a displayed on web content 622 in FIG. 6B). In some embodiments, increasing the brightness of the first portion of the user interface object relative to the brightness of the second portion of the user interface object includes in accordance with a determination that the content that is displayed above the threshold brightness is displayed at a second location (e.g., the location of 616 in FIG. 6D) that is different from the first location, the first portion of the user interface object corresponds to a second area of the user interface object (e.g., the area of glow 630a displayed on web content 622 in FIG. 6D) that is different from the first area (e.g., different areas of the user interface object are brightened based on a location of the bright media). Conditionally increasing the brightness of different areas of the user interface object based on the location of the content that is displayed above the threshold brightness performs an operation when a set of conditions has been met without requiring further user input, improves how user interface objects are displayed when bright content is also displayed, and prevents keeping the whole display in an HDR range.

In some embodiments, increasing the brightness of the first portion of the user interface object (e.g., 619a, 621a, and/or 645a) relative to the brightness of the second portion of the user interface object (e.g., 619b, 621b, and/or 645b) includes in accordance with a determination that the media has a first set of characteristics (e.g., a magnitude of a brightness, size, and/or shape of 616) that includes a first magnitude of brightness of the media, the first portion of the user interface object is brightened by a first amount that is based on the first magnitude of brightness (e.g., 630a is based on the magnitude of a brightness, size, and/or shape of 616) (e.g., and not based on a second magnitude of brightness). In some embodiments, increasing the brightness of the first portion of the user interface object relative to the brightness of the second portion of the user interface object includes in accordance with a determination that the media has a second set of characteristics that includes a second magnitude of brightness of the media that is different from the first magnitude of brightness of the media, the first portion of the user interface object is brightened by a second amount, different from the first amount, that is based on the second magnitude of brightness and is not based on the first magnitude of brightness (e.g., 630a is based on a brightness, size, and/or shape of 616) (e.g., the amount of increased brightness of the first portion of the user interface object (e.g., the glow effect) depends on how bright the media is). Conditionally increasing the brightness of the first portion of the user interface object by an amount that is based on the magnitude of brightness of the media performs an operation when a set of conditions has been met without requiring further user input, improves how user interface objects are displayed when bright content is also displayed, and reduces the amount of increased brightness displayed on some portions of the display which conserves battery power and prevents keeping the whole display in an HDR range.

In some embodiments, the first set of characteristics includes the content (e.g., 616, 659, and/or 663) that is displayed above the threshold brightness having a first magnitude of brightness (e.g., 630a is based on a magnitude of the brightness of 616). In some embodiments, the second set of characteristics includes the content that is displayed above the threshold brightness having a second magnitude of brightness that is different from the first magnitude of brightness (e.g., 630a is based on the brightness of 616). Conditionally increasing the brightness of the user interface object by different amounts based on the content that is displayed above the threshold brightness having different magnitudes of brightness performs an operation when a set of conditions has been met without requiring further user input, improves how user interface objects are displayed when bright content is also displayed, and the amount of increased brightness displayed on some portions of the display which conserves battery power and prevents keeping the whole display in an HDR range.

In some embodiments, the first set of characteristics includes the content (e.g., 616, 659, and/or 663) that is displayed above the threshold brightness having a first area (e.g., 630a is based on the size of 616). In some embodiments, the second set of characteristics includes the content that is displayed above the threshold brightness having a second area that is different from the first area (e.g., 630a is based on the size of 616). In some embodiments, a magnitude of increase in brightness of the first portion of the user interface object relative to the brightness of the second portion of the user interface object is based on a size of the content that is displayed above the threshold brightness. Conditionally increasing the brightness of the user interface object by different amounts based on the size of the content that is displayed above the threshold brightness performs an operation when a set of conditions has been met without requiring further user input, improves how user interface objects are displayed when bright content is also displayed, and controls the size of the portion that has increased brightness which conserves battery power and prevents keeping the whole display in an HDR range.

In some embodiments, increasing the brightness of the first portion (e.g., 619a, 621a, and/or 645a) of the user interface object (e.g., 606a-606c, 612, 620, 622, and/or 646) includes in accordance with a determination that the content that is displayed above the threshold brightness has a first shape (e.g., shape of 616) (e.g., round, straight, square, rectangular, and/or circular), the first portion of the user interface object has a second shape that is based on (e.g., the same as or condition on) the first shape (e.g., shape of 630a on 622 is based on shape of 616). In some embodiments, increasing the brightness of the first portion of the user interface object includes in accordance with a determination that the content that is displayed above the threshold brightness has a third shape that is different from the first shape, the first portion of the user interface object has a fourth shape, different from the second shape (e.g., the shape of the glow depends on the shape of the bright media content), that is based on (e.g., the same as or condition on) the third shape (e.g., shape of 630j on 622 is based on shape of 659). Conditionally changing the shape of the portion of the user interface object based on the shape of the content that is displayed above the threshold brightness performs an operation when a set of conditions has been met without requiring further user input, improves how user interface objects are displayed when bright content is also displayed, and controls the shape of the portion that has increased brightness which conserves battery power and prevents keeping the whole display in an HDR range.

In some embodiments, the first shape (and/or the third shape) of the content (e.g., the shape of 616 in FIG. 6B) that is displayed above the threshold brightness includes a first boundary (e.g., the boundary of 616) (e.g., edge and/or border). In some embodiments, the second shape (and/or fourth shape) of the first portion of the user interface object (e.g., the shape of a portion of 630a) is based on (e.g., is in accordance with) blurring of a portion of the first shape that includes the first boundary (e.g., 630a includes blurring a portion of 616, as depicted by the shape of 634a-634c in FIG. 6B) (e.g., the shape of the glow is based on blurring a boundary of the bright media). In some embodiments, the shape of the glow is based on a blurring of the shape of the bright media. Including a blurring of a portion of a shape of the bright content as part of the shape of the first portion of the user interface object improves how user interface objects are displayed when bright content is also displayed and controls the blurring of the portions that are displayed with increased brightness which conserves battery power and prevents keeping the whole display in an HDR range.

In some embodiments, the second shape (and/or fourth shape) of the first portion of the user interface object (e.g., the shape of 630a) is based on (e.g., is in accordance with) enlarging (e.g., increasing a size of and/or expanding) the first shape (e.g., 630a is based on enlarging the shape of 616, as depicted by the size of 634a-634c in FIG. 6B) (e.g., the glow is based on enlarging the shape of the bright HDR content). Enlarging the first shape of the content that is displayed above a brightness threshold so as to provide a shape of the increased brightness performs an operation when a set of conditions has been met without requiring further user input, improves how user interface objects are displayed when bright content is also displayed, and controls the shape of the portion that has increased brightness which conserves battery power and prevents keeping the whole display in an HDR range.

In some embodiments, increasing the brightness of the first portion of the user interface object (e.g., 619a, 621a, and/or 645a) includes displaying gradually decreasing amounts of increased brightness to areas of the first portion as distance of the areas to the content that is displayed above the threshold brightness increases (e.g., 630a gradually decreases in brightness as gets further from 616, as depicted by the shading of 634a-634c in FIG. 6B) (e.g., the glow gradually decreases as it extends further away from the bright media) (e.g., portions further from the bright media are less brighter than portions closer to the bright media content). Gradually decreasing amounts of increased brightness to areas of the first portion as distance of the areas to the content that is displayed above the threshold brightness increases, improves how user interface objects are displayed when bright content is also displayed and prevents keeping the whole display in an HDR range.

In some embodiments, while the first portion (e.g., 619a, 621a, and/or 645a) of the user interface object (e.g., 606a-606c, 612, 620, 622, and/or 646) has increased brightness relative to the brightness of the second portion (e.g., 619b, 621b, and/or 645b) of the user interface object, the computer system (e.g., 600 and/or 648a-648c) detects a change (e.g., change in display location, change in size, change in brightness, and/or change in color) in the portion of the media that includes the content that is displayed above the threshold brightness (e.g., 600 detects a change in 659 throughout FIGS. 6H-6K). In response to detecting the change in the portion of the media that includes the content that is displayed above the threshold brightness, the computer system (e.g., 600 and/or 648a-648c) modifies (e.g., changing and/or altering) (e.g., automatically and/or without user input) a characteristic (e.g., display location, size, brightness level, and/or color) of the increased brightness of the first portion of the user interface object (e.g., there is a change in 630j and/or 630k throughout FIGS. 6H-6K) (e.g., the glow changes when there is a change in the bright media content). In some embodiments, detecting a change in the portion of the media that includes the content that is displayed above the threshold brightness includes detecting that the content that is displayed above the threshold brightness moves (e.g., while still being displayed) and/or ceases to be displayed. In some embodiments, in response to detecting the change in the portion of the media that includes the content that is displayed above the threshold brightness, the computer system (e.g., 600 and/or 648a-648c) modifies a characteristic (e.g., display location, size, brightness level, and/or color) of a brightness of the second portion of the user interface object (e.g., the second portion of the user interface object begins to glow and/or an existing glow of the second portion of the user interface object changes when there is a change in the bright media content). In some embodiments, the computer system detects a change in the portion of the media when the media corresponds to a video that is being played. In some embodiments, the computer system detects a change in the portion of the media when the media corresponds a photo that is replaced by a different photo. Modifying a characteristic of the increased brightness of the first portion of the user interface object in response to detecting a change in the portion of the media that includes the content that is displayed above the threshold brightness automatically changes a characteristic of the portion that has increased brightness without requiring further user input, prevents keeping the whole display in an HDR range, improves how the portion that has increased brightness changes when bright media content also changes, and controls how bright the portion that has increased brightness is, thereby conserving battery power.

In some embodiments, detecting the change in the portion of the media that (e.g., detecting a change in 659 throughout FIGS. 6H-6I) includes the content that is displayed above the threshold brightness includes detecting movement of the content that is displayed above the threshold brightness (e.g., 659 moves between FIGS. 6H-6I) (e.g., the bright media content moves up, down, left, and/or right). In some embodiments, modifying the characteristic of the increased brightness of the first portion of the user interface object includes modifying a brightness level (e.g., a brightness intensity and/or amount) of the increased brightness of the first portion of the user interface object (e.g., 630j moves between FIGS. 6H-6I and, as such, the brightness of 622 in FIG. 6H is decreased relative to the brightness of 622 FIG. 6I). In some embodiments, in response to the computer system detecting the content that is displayed above the threshold brightness moves further away from the first portion of the user interface object, the computer system decreases a brightness level of the increased brightness. In some embodiments, in response to the computer system detecting the content that is displayed above the threshold brightness moves closer to the first portion of the user interface object, the computer system increases a brightness level of the increased brightness. Modifying a brightness level of the increased brightness in response to detecting movement in the portion of the media that includes the content that is displayed above the threshold brightness automatically changes a characteristic of the portion that has increased brightness without requiring further user input, prevents keeping the whole display in an HDR range, improves how the portion that has increased brightness changes when bright media content also changes, and controls how bright the portion that has increased brightness is, thereby conserve battery power.

In some embodiments, detecting the change in the portion of the media that includes the content that is displayed above the threshold brightness (e.g., 600 detects a change in 659 and/or 663 throughout FIGS. 6H-6K) includes detecting a change (e.g., increase and/or decrease) in a size of the content that is displayed above the threshold brightness (e.g., size of 659 in FIG. 6H is different from the size of 659 in FIG. 6K) (e.g., the content becomes smaller or larger). In some embodiments, modifying the characteristic of the increased brightness of the first portion of the user interface object includes modifying a brightness level (e.g., a brightness intensity and/or amount) of the increased brightness of the first portion of the user interface object (e.g., the brightness of glow 630j in FIG. 6H becomes less bright relative to the brightness of 630j in FIG. 6K). In some embodiments, in response to the computer system detecting a decrease in size of the content that is displayed above the threshold brightness, the computer system decreases a brightness level of the increased brightness. In some embodiments, in response to the computer system detecting an increase in size of the content that is displayed above the threshold brightness, the computer system increases a brightness level the increased brightness. In some embodiments, in response to the computer system detecting a change in size of the content that is displayed above the threshold brightness, the size of the first portion changes (e.g., decreases in size as the size of the content displayed above the threshold brightness decreases and/or increases in size as the size of the content displayed above the threshold brightness increases). Modifying a brightness level of the first portion of the user interface object in response to detecting a change in size in the portion of the media that includes the content that is displayed above the threshold brightness automatically changes a characteristic of the portion that has increased brightness without requiring further user input, prevents keeping the whole display in an HDR range, improves how the portion that has increased brightness changes when bright media content also changes, and controls how bright the portion that has increased brightness, thereby conserving battery power.

In some embodiments, detecting the change in the portion of the media that includes the content that is displayed above the threshold brightness (e.g., 600 detects a change in 659 and/or 663 throughout FIGS. 6H-6K) includes detecting a change (e.g., increase and/or decrease) in brightness of the content that is displayed above the threshold brightness (e.g., a brightness of 659 in FIG. 6H becomes less bright than the brightness of 659 in FIG. 6K) (e.g., the bright media becomes brighter or becomes less bright). In some embodiments, modifying the characteristic of the increased brightness of the first portion of the user interface object includes modifying a brightness level (e.g., a brightness intensity and/or amount) of the increased brightness of the first portion of the user interface object (e.g., the brightness of glow 630j in FIG. 6H becomes less bright relative to the brightness of 630j in FIG. 6K). In some embodiments, in response to the computer system detecting a decrease in brightness of the content that is displayed above the threshold brightness, the computer system decreases a brightness level of the increased brightness. In some embodiments, in response to the computer system detecting an increase in brightness of the content that is displayed above the threshold brightness, the computer system increases a brightness level of the increased brightness (e.g., the increased brightness of the first portion of the user interface object). Modifying a brightness level of the increased brightness in response to detecting a change in brightness in the portion of the media that includes the content that is displayed above the threshold brightness automatically changes a characteristic of the portion that has increased brightness without requiring further user input, prevents keeping the whole display in an HDR range, improves how the portion that has increased brightness changes when bright media content also changes, and controls how bright the portion that has increased brightness is, thereby conserving battery power.

In some embodiments, detecting the change in the portion of the media that includes the content that is displayed above the threshold brightness (e.g., 600 detects a change in 659 and/or 663 throughout FIGS. 6H-6K) includes detecting a change in color (e.g., 664 and/or 666) of the content that is displayed above the threshold brightness (e.g., 657 at FIG. 6I includes 664 and/or 666) (e.g., the bright media content begins to include content having a different color). In some embodiments, modifying the characteristic of the increased brightness of the first portion (e.g., 619a, 621a, and/or 645a) of the user interface object includes modifying a color of the increased brightness in addition to modifying a brightness of the first portion of the user interface object (e.g., 630k that is displayed at 622 at FIG. 6I includes 664 and/or 666). In some embodiments, in response to the computer system detecting the content that is displayed above the threshold brightness includes a first color (e.g., 664 and/or 666), the computer system displays a first amount of the first color (e.g., a first amount of 664 and/or 666) at the first portion of the user interface object. In some embodiments, in response to the computer system detecting the content that is displayed above the threshold brightness includes a second color (e.g., 664 and/or 666) different from the first color, the computer system displays a first amount of the second color (e.g., a first amount of 664 and/or 666) at the first portion of the user interface object (and/or the second portion of the user interface object). Modifying a color of the increased brightness in response to detecting a change in color in the portion of the media that includes the content that is displayed above the threshold brightness automatically changes a characteristic of the portion that has increased brightness without requiring further user input, prevents keeping the whole display in an HDR range, improves how the portion that has increased brightness changes when bright media content also changes, and controls how bright the portion that has increased brightness is, thereby conserving battery power.

In some embodiments, the first set of criteria is satisfied independent of an application (e.g., 608, 644 and/or 656) (e.g., a media library, a web browser, and/or a file manager) initiating (e.g., triggering and/or causing) the display of the content that is displayed above the threshold brightness (e.g., 603a is displayed when 628 is being displayed in 608 and/or 644) (e.g., the glow is displayed regardless of the application being used to view the bright media content). In some embodiments, the computer system displays the glow based on the HDR content when the HDR content is viewed in different applications (e.g., a media library, a web browser, and/or a file manager). Allowing the first set of criteria to be satisfied independent of the application that initiates the display of the content that is displayed above the threshold brightness allows the portion that has increased brightness to be displayed regardless of the application being used to view the bright media content, prevents keeping the whole display in an HDR range, and improves how user interface objects are displayed when bright content is also displayed.

In some embodiments, the first user interface (e.g., that includes the user interface object) is a user interface of a first application (e.g., 608, 644, and/or 656) (e.g., a media library, a web browser, a communication application (e.g., a text messaging application and/or an email application), and/or a file manager). In some embodiments, in response to receiving the request to display the media and in accordance with the determination that the first set of criteria is satisfied, the computer system (e.g., 600 and/or 648a-648c) increases a brightness of a first portion (e.g., 619a and/or 621a) of a second user interface (e.g., 604 and/or 618) (e.g., that includes the content that is displayed above the threshold brightness) of a second application (e.g., a media library, a web browser, a communication application (e.g., a text messaging application and/or an email application), and/or a file manager), different from the first application, relative to a brightness of a second portion (e.g., 619b and/or 621b) of the second user interface (e.g., 621a and/or 618) (e.g., a glow caused by bright media of one application extends from the user interface of that application into a user interface of a different application). In some embodiments, the first user interface of the first application (e.g., that includes the first portion of the user interface object that is brightened) does not include the content that is displayed above the threshold brightness. In some embodiments, in accordance with the determination that the first set of criteria is not satisfied, the computer system forgoes increasing the brightness of the first portion of the second user interface of the second application relative to the brightness of the second portion of the second user interface. Increasing a brightness of a first portion of the second user interface (e.g., that includes the content that is displayed above the threshold brightness) of the second application relative to a brightness of a second portion of the second user interface when the first set of criteria is satisfied an increased brightness across different applications, prevents keeping the whole display in an HDR range, and improves how portions of different applications are displayed when bright content is also displayed.

In some embodiments, the first set of criteria includes a criterion that is satisfied when the display generation component (e.g., 602 and/or 650a-650c) supports high dynamic range (HDR) (e.g., 603a is displayed when 602 is an HDR display). In some embodiments, in accordance with a determination that the first set of criteria is not satisfied (e.g., the display generation component does not support HDR), forgoing increasing the brightness of the first portion of the user interface object relative to the brightness of the second portion of the user interface object (e.g., the first portion of the user interface object does not appear to glow). Increasing a brightness of a first portion of the user interface object relative to a brightness of a second portion of the user interface object when the display generation component supports high dynamic range (HDR), performs an operation when a set of conditions has been met without requiring further user input, prevents keeping the whole display in an HDR range, and improves how user interface objects are displayed when bright content is also displayed on displays having a specific characteristic.

In some embodiments, increasing the brightness of the first portion of the user interface object (e.g., 619a, 621a, and/or 645a) includes in accordance with a determination that the content that is displayed above the threshold brightness includes a first color (e.g., 664 and/or 666), updating the first portion of the user interface object to include the first color without including a second color (e.g., 664 and/or 666) that is different from the first color. In some embodiments, increasing the brightness of the first portion of the user interface object (e.g., 619a, 621a, and/or 645a) includes in accordance with a determination that the content that is displayed above the threshold brightness includes the second color (e.g., 664 and/or 666), updating the first portion of the user interface object to include the second color (e.g., 630k includes 664 and/or 666) (e.g., a color of the glow is based on a color of the bright media content) without including the first color. In some embodiments, the brightness of the first portion of the user interface object is increased based on both the first and second color (e.g., the content that is displayed above the threshold brightness includes both the first color and the second color). In some embodiments, the brightness of the first portion of the user interface object is increased based on the first color and not the second color (e.g., because the bright media content includes the first color and not the second color) (or, optionally, vice versa). Conditionally updating the first portion of the user interface object to include different colors based on the color of the content that is displayed above the threshold brightness performs an operation when a set of conditions has been met without requiring further user input, prevents keeping the whole display in an HDR range, and improves how user interface objects are displayed when bright content having different colors is also displayed.

In some embodiments, increasing the brightness of the first portion of the user interface object (e.g., 619a, 621a, and/or 645a) includes adjusting a first sub-region of the first portion of the first user interface object (e.g., a first sub-region of 622 in FIG. 6I) (and/or adjusting a first sub-region of the first user interface) with a first color (e.g., 663 includes 664 and/or 666). In some embodiments, increasing the brightness of the first portion of the user interface object includes adjusting a second sub-region of the first portion of the first user interface object (e.g., a second sub-region of 622 in FIG. 6I) (and/or adjusting a second sub-region of the first user interface) with a second color, wherein the second sub-region is different from the first sub-region and the second color is different from the first color (e.g., 663 includes 664 and/or 666). In some embodiments, the glow has a color that varies spatially (e.g., different portions of the glow concurrently have different colors) (e.g., because the color of the content that is displayed above the threshold brightness also varies spatially). In some embodiments, the different colors of the glow correspond to (e.g., are based on and/or are the same as) the different colors of the content that is displayed above the threshold brightness. Adjusting the different sub-regions of the brightness of the first portion of the user interface object using different colors performs an operation when a set of conditions has been met without requiring further user input, prevents keeping the whole display in an HDR range, and improves how user interface objects are displayed when bright content having different colors is also displayed.

In some embodiments, increasing the brightness of the first portion of the user interface object (e.g., 619a, 621a, and/or 645a) does not cause (e.g., trigger and/or initiate) a simulated shadow (e.g., 624) (e.g., darkening and/or dimming) to be displayed (e.g., the glow does not cause a shadow to be displayed). In some embodiments, a simulated shadow is a shadow generated by the computer system independently of the content (e.g., image and/or text) of a user interface. In some embodiments, increasing the brightness of the first portion of the user interface object does not cause a shadow to be displayed on the user interface object, in an area adjacent to the user interface object, on a portion of a user interface that includes the user interface object, and/or a user interface that is different from the user interface that includes the user interface object. Not causing a shadow to be displayed when the brightness of the user interface object is increased improves how user interface objects are displayed when bright media content is also displayed and prevents the darkening of a portion of the display in response to brightening nearby user interface objects.

In some embodiments, prior to increasing the brightness of the first portion of the user interface object (e.g., prior to displaying 619a, 621a, and/or 645a), the computer system (e.g., 600 and/or 648a-648c) displays, via the displaying generation component (e.g., 602 and/or 650a-650c), one or more simulated shadows (e.g., 624) of user interface objects (e.g., 608) (e.g., 624 is displayed prior to displaying 619a, 621a, and/or 645a). In some embodiments, the computer system maintains display, via the display generation component (e.g., 602 and/or 650a-650c), of the one or more simulated shadows of user interface objects while the brightness of the first portion of the user interface object relative to the brightness of the second portion of the user interface object is increased (e.g., 624 is still displayed when 630a is displayed). In some embodiments, the computer system concurrently displays a simulated shadow (e.g., a shadow between user interface objects and/or adjacent to user interface objects) while the brightness of the first portion of the user interface object is increased relative to the brightness of the second portion of the user interface object. In some embodiments, the computer system displays the simulated shadow independently of the content (e.g., image and/or text) of a user interface. In some embodiments, the computer system displays the simulated shadow based on a size and/or location of a user interface (e.g., an application window). In some embodiments, the simulated shadow is not a shadow that corresponds to (or is associated with) the content of a user interface. Maintaining display of the one or more simulated shadows of user interface objects while the brightness of the first portion of the user interface object relative to the brightness of the second portion of the user interface object is increased improves how user interface objects are displayed when bright media content is also displayed and prevents keeping the whole display in an HDR range.

In some embodiments, the first set of criteria includes a content location criterion that is satisfied when the content (e.g., 616, 659, and/or 663) that is displayed above the threshold brightness is displayed within a threshold distance of an edge (e.g., 668a-668d) (e.g., boundary or border) (e.g., a top edge, a bottom edge, a right edge, and/or left edge) of the media. In some embodiments, the brightness of the first portion of the user interface object is increased relative to the brightness of the second portion of the user interface object while (e.g., in accordance with a determination that) the media includes content that is displayed above the threshold brightness that is within the threshold distance of the edge (e.g., 659 in FIG. 6K). In some embodiments, in accordance with a determination that the first set of criteria is not satisfied (e.g., the content location criterion is not satisfied, even if all other criteria of the first set of criteria are satisfied) while the media includes content that is displayed above the threshold brightness and does not include content that is displayed above the threshold brightness within the threshold distance of the edge (e.g., 659 in FIG. 6J), the computer system (e.g., 600 and/or 648a-648c) forgoes increasing the brightness of the first portion of the user interface object relative to the brightness of the second portion of the user interface object (e.g., no glow is displayed in FIG. 6J) (e.g., no glow is applied to the first portion of the user interface object because the bright media content is in the center of the media as opposed to near the edge of the media). In some embodiments, a first HDR region in the middle of the HDR content (e.g., far from the edge of the HDR content and/or far from the edge of the media) doesn't create a glow (e.g., does not increase a brightness of any user interface objects adjacent to the bright media content) and a second HDR region that is along the edge of the HDR content (e.g., near the edge of the HDR content and/or near the edge of the media) creates a glow (e.g., increases a brightness of at least one user interface object adjacent to the bright media content). Conditionally increasing a brightness of a first portion of the user interface object relative to a brightness of a second portion of the user interface object while the media includes content that is displayed above the threshold brightness and based on a first set of criteria being satisfied, where the first set of criteria includes a content location criterion that is satisfied when the content that is displayed above the threshold brightness is displayed within a threshold distance of an edge of the media, performs an operation when a set of conditions has been met without requiring further user input, improves how user interface objects are displayed when bright content is also displayed, and prevents keeping the whole display in an HDR range.

In some embodiments, the first set of criteria includes a brightness level criterion that is satisfied when a current brightness level (e.g., 652) (e.g., 70% brightness level, 80% brightness level, or 90% brightness level) of the display generation component (e.g., 602 and/or 650a-650c) is below a threshold brightness level (e.g., 630d is displayed when 652 for 648a in FIG. 6E is decreased from 100% to 50% in FIG. 6D) (e.g., 100% brightness level, 90% brightness level, 70% brightness level, and/or a maximum allowed brightness level) (e.g., the glow is displayed only when the brightness level is below the threshold brightness level and/or the maximum allowed brightness). In some embodiments, when the current brightness level is above the threshold brightness level, the computer system does not increase the brightness of the first portion of the user interface object relative to the brightness of the second portion of the user interface object, and when the current brightness level drops to below the threshold brightness level, the computer system increases the brightness of the first portion of the user interface object relative to the brightness of the second portion of the user interface object. In some embodiments, the brightness level is a configurable setting (e.g., manually and/or automatically) of the display generation component. In some embodiments, the first set of criteria includes a first display generation component type criterion that is satisfied when the display generation component is a first display generation component type (e.g., a non-HDR display and/or an SDR display) (e.g., a non-HDR display can only display the glow if the current brightness level is below a maximum level, whereas an HDR display can display the glow independently of the brightness level (e.g., regardless of whether the brightness level is at 100% brightness level or not)). Increasing a brightness of a first portion of the user interface object relative to a brightness of a second portion of the user interface object when a first set of criteria is satisfied, where the first set of criteria includes a brightness level criterion that is satisfied when a current brightness level of the display generation component is below a threshold brightness level, performs an operation when a set of conditions has been met without requiring further user input and improves how user interface objects are displayed when bright content is displayed on a display generation component having an ability to be configured to different brightness levels.

In some embodiments, in accordance with a determination that the first set of criteria is not satisfied (e.g., 616 does not have an HDR range in FIG. 6A and/or 614 is being displayed) (e.g., the portion of the media does not include HDR content and/or does not include content that is displayed above the threshold brightness), the computer system (e.g., 600 and/or 648a-648c) forgoes increasing the brightness of the first portion of the user interface object relative to the brightness of the second portion of the user interface object (e.g., 630a is not displayed in FIG. 6A) (e.g., the first portion of the user interface object does not appear to glow). In some embodiments, when the media does not include HDR content, a glow is not displayed. Conditionally increasing a brightness of a first portion of the user interface object relative to a brightness of a second portion of the user interface object when the first set of criteria is satisfied performs an operation when a set of conditions has been met without requiring further user input, prevents or reduces the need to keep the whole display in an HDR range, and improves how user interface objects are displayed when bright content is also displayed.

In some embodiments, the content that is displayed above a threshold brightness includes a first portion of content (e.g., 659 in FIG. 6I) that is displayed concurrently with a second portion of content (e.g., 663 in FIG. 6I) different from the first portion of content (e.g., the bright media includes bright content in different areas of the image or there are two different media items with content that is displayed above the threshold brightness). In some embodiments, increasing the brightness of the first portion of the user interface object includes, in accordance with a determination that the first portion of content is within a threshold distance of the second portion of content (e.g., 659 is near 663) (e.g., the two different portions of bright media content are near each other), increasing the brightness of the first portion of the user interface object based on a combination of a characteristic (e.g., shape, color, brightness, and/or size) of the first portion of content and a characteristic of the second portion of content (e.g., a color, brightness, and/or shape of 630j is included with a color, brightness, and/or shape of 630k) (e.g., a glow caused by one portion of content is combined with a glow caused by another portion of content). In some embodiments, in accordance with a determination that the first portion of content is not within the threshold distance of the second portion of content (e.g., the two different portions of bright media content are not near each other), the brightness of the first portion of the user interface object is increased based on the characteristic of the first portion of content without increasing the brightness of the first portion of the user interface object based on the characteristic of the second portion of content. In some embodiments, the first portion of content causes an increased brightness in a first area of the display while the second portion of content causes an increased brightness in a second area of the display, different (e.g., non-overlapping, semi-overlapping, and/or the first area includes an area that is not included in the second area) from the first area. Conditionally increasing a brightness of a first portion of the user interface object relative to a brightness of a second portion of the user interface object based on a combination of a characteristic of the first portion of content and a characteristic of the second portion of content performs an operation when a set of conditions has been met without requiring further user input, prevents or reduces the need to keep the whole display in an HDR range, and improves how user interface objects are displayed when bright content is also displayed.

In some embodiments, increasing the brightness of the first portion of the user interface object (e.g., 619a, 621a, and/or 645a) relative to the brightness of a second portion of the user interface object (e.g., 619b, 621b, and/or 645b) includes, in accordance with a determination that the media is displayed in a foreground user interface (e.g., 608 is in the foreground and 618 is in the background in FIG. 6B) (e.g., the media is in a window that is a foreground window in a window layer order) (e.g., of a plurality of user interfaces), increasing the brightness of the first portion of the user interface object by a first amount of brightness (e.g., the brightness of 630a in FIG. 6B). In some embodiments, increasing the brightness of the first portion of the user interface object relative to the brightness of a second portion of the user interface object includes, in accordance with a determination that the content that is displayed in a background user interface (e.g., 608 is in the background and 618 is in the foreground) (e.g., the media is in a window that is a background window in a window layer order) (e.g., of a plurality of user interfaces), increasing the brightness of the first portion of the user interface object by a second amount of brightness that is less than the first amount of brightness (e.g., the brightness of 630a would not be as bright as it is in FIG. 6B when 608 is in the background) (e.g., the glow is brighter when the bright media content is in a user interface that is in the foreground as compared to the brightness of the glow when the bright media content is in a user interface that is in the background). Conditionally increasing a brightness of a first portion of the user interface object relative to a brightness of a second portion of the user interface object based on whether the bright media is in a foreground user interface or background user interface performs an operation when a set of conditions has been met without requiring further user input, prevents keeping the whole display in an HDR range, and improves how user interface objects are displayed when bright content is also displayed.

FIGS. 8A-8K illustrate exemplary user interfaces for modifying the brightness of user interface objects, in accordance with some embodiments. The user interfaces in these figures are used to illustrate the processes described below, including the processes in FIG. 9.

At FIG. 8A, computer system 800 displays, on display 802, various user interfaces and objects. The user interfaces and objects are depicted with various levels of gray shading to illustrate the different levels of brightness of display 802. Computer system 800 changes (e.g., increases and/or decreases) the brightness of particular user interfaces and objects based on specific conditions being met. In some embodiments, the areas shown in white are brighter than areas shown in light gray, which are brighter than areas shown in dark gray, which are brighter than areas shown in black. In some embodiments, computer system 800 includes one or more features of devices 100, 300, 500, and/or 600. Throughout FIGS. 8A-8H, content that is in the foreground of the displayed user interface is indicated by a bold border for ease of understanding.

In some embodiments, display 802 is a high dynamic range (HDR) display (or, optionally, is not an HDR display). In some embodiments, display 802 is a display that has a dynamic range that is wider than a standard dynamic range (SDR) display. In some embodiments, a dynamic range is the range of brightness (e.g., a range between the brightest level to the darkest level) and/or colors (e.g., a range and/or variation in colors). When referring to a display, in some embodiments, a dynamic range is a range of brightness and/or a range of colors that the display can display (e.g., produce). In some embodiments, an HDR display can display a range of brightness from 0.05 nits (e.g., cd/m²) to 1,000 nits (e.g., cd/m²). In some embodiments, an HDR display includes a range of brightness from 0.0005 nits (e.g., cd/m²) to 540 nits (e.g., cd/m²). In some embodiments, an HDR display is capable of displaying a brightness of at least 1,000 nits (or, optionally, a range of 1,000 nits to 4,000 nits). In some embodiments, a non-HDR display can display a maximum brightness that is less than a maximum brightness of an HDR display. In some embodiments, a non-HDR display can display a maximum brightness of less than 1,000 nits (or, optionally, a maximum brightness of 100 nits).

In some embodiments, when referring to media (e.g., a photo and/or a video), a dynamic range is the range of brightness (e.g., a range between the brightest level to the darkest level) and/or colors (e.g., a range and/or variation in colors) included in the media. In some embodiments, non-HDR media has a maximum target brightness that is less than the maximum target brightness of HDR media. In some embodiments, HDR media (or, optionally, an HDR display) satisfies the criteria defined by one or more universal HDR standards, including HDR10, HDR10+, Advanced HDR, and/or Dolby Vision.

At FIG. 8A, computer system 800 is displaying, via display 802, document window 810, notification 812A, indication 814 of a digital assistant (as computer system 800 outputs digital assistant audio 806A), icon 822 corresponding to a first media, icon 832 corresponding to a second media, and cursor 804. At FIG. 8A, document window 810 includes text 810A and document window 810 is in the foreground of the user interface, as indicated by the bold border around document window 810. At FIG. 8A, the brightness of all content being displayed is within a standard range of brightness (e.g., is non-HDR). For example, because notification 812A and indication 814 are not overlaid on content that is displayed with a brightness that is above the standard range of brightness, computer system 800 displays notification 812A and indication 814 with brightnesses that are within the standard range of brightness (e.g., notification 812A and indication 814 are displayed as SDR and/or not HDR). In some embodiments, cursor 804 is controlled via touch inputs, air gestures, mouse inputs, and/or voice inputs. At FIG. 8A, computer system 800 detects a user input corresponding to activation of icon 822 via cursor 804.

At FIG. 8B, in response to detecting the user input corresponding to activation of icon 822, computer system 800 displays, via display 802, first media window 820, including representation 820A of the first media. Computer system 800 overlays playback control 820B and metadata text 820C on representation 820A. Playback control 820B, when activated (e.g., clicked and/or tapped on), starts playback of the first media. Metadata text 820C provides textual information about the first media, such as the date and location that the first media was recorded. First media window 820, and therefore representation 820A, is in the foreground of the user interface, as indicated by the bold border around first media window 820. Some portions (e.g., the sky) of the first media have a target brightness that is above the standard range of brightness and other portions (e.g., the ocean) of the first media have a target brightness that is within the standard range of brightness. At FIG. 8B, because first media window 820 is in the foreground of the user interface, computer system 800 displays the portions of representation 820A of the first media with target brightnesses above the standard range of brightness at brightnesses that are above the standard range of brightness (e.g., the HDR image is output as HDR). Because playback control 820B and metadata text 820C are overlaid on content that is displayed with a brightness that is above the standard range of brightness, computer system 800 displays playback control 820B and metadata text 820C with a higher brightness (e.g., HDR) than if the elements were not overlaid on content displayed with a brightness above the standard range of brightness. In some embodiments, this enables the user to better distinguish playback control 820B and metadata text 820C from the HDR content on which the elements are overlaid. At FIG. 8B, computer system 800 detects a user input corresponding to selection of document window 810.

At FIG. 8C, in response to detecting the user input corresponding to selection of document window 810, computer system 800 shifts first media window 820 out of the foreground of the user interface and shifts document window 810 into the foreground of the user interface, as indicated by the bold border around document window 810. At FIG. 8C, because first media window 820 is not in the foreground of the user interface, computer system 800 displays representation 820A with a brightness that is within the standard range of brightness. For example, computer system 800 displays the portions of representation 820A of the first media with target brightnesses above the standard range of brightness at brightnesses that are within the standard range of brightness (e.g., the HDR image is displayed as SDR and/or not HDR). Thus, computer system 800 has reduced the brightness and dynamic range of representation 820A of the first media. Because playback control 820B and metadata text 820C are overlaid on content that is displayed with a brightness that is within the standard range of brightness, computer system 800 displays playback control 820B and metadata text 820C with a lower brightness (e.g., SDR and/or non-HDR) than if the elements were overlaid on content displayed with a brightness above the standard range of brightness. At FIG. 8C, computer system 800 detects a user input corresponding to selection of first media window 820.

At FIG. 8D, in response to detecting the user input corresponding to selection of first media window 820, computer system 800 shifts document window 810 out of the foreground of the user interface and shifts first media window 820 into the foreground of the user interface, as indicated by the bold border around first media window 820. At FIG. 8D, because first media window 820 is in the foreground of the user interface, computer system 800 displays the portions of representation 820A of the first media with target brightnesses above the standard range of brightness at brightnesses that are above the standard range of brightness (e.g., the HDR image is output as HDR). While displaying representation 820A in the foreground of the user interface, computer system 800 receives an incoming message and, in response, displays notification 812B corresponding to the incoming message, as shown in FIG. 8D. Because at least a portion of notification 812B is overlaid on content that is displayed with a brightness that is above the standard range of brightness, computer system 800 displays notification 812B with a higher brightness than if notification 812B was not overlaid on content displayed with a brightness above the standard range of brightness. For example, because notification 812B is partially overlaid on portions of representation 820A that are displayed in HDR, computer system 800 displays notification 812B in HDR. Thus, computer system 800 displays notification 812B of FIG. 8D with a higher brightness and/or with a higher dynamic range as compared to notification 812A of FIG. 8A. While displaying representation 820A in the foreground of the user interface, computer system 800 initiates the digital assistant and, in response, displays indication 814 of the digital assistant and outputs digital assistant audio 806B, as shown in FIG. 8D. Because at least a portion of indication 814 is overlaid on content that is displayed with a brightness that is above the standard range of brightness, computer system 800 displays indication 814 with a higher brightness than if indication 814 was not overlaid on content displayed with a brightness above the standard range of brightness. For example, because indication 814 is partially overlaid on portions of representation 820A that are displayed in HDR, computer system 800 displays indication 814 in HDR. Thus, computer system 800 displays indication 814 of FIG. 8D with a higher brightness and/or with a higher dynamic range as compared to indication 814 of FIG. 8A. Because playback control 820B and metadata text 820C are overlaid on content that is displayed with a brightness that is above the standard range of brightness, computer system 800 displays playback control 820B and metadata text 820C with a higher brightness (e.g., HDR) than if the elements were not overlaid on content displayed with a brightness above the standard range of brightness. At FIG. 8D, computer system 800 detects a user input corresponding to activation of icon 832 via cursor 804. In some embodiments, displaying the content with a higher brightness when the content is overlaid on HDR content enables the user to better distinguish the content from the HDR content on which the content is overlaid.

At FIG. 8E, in response to detecting the user input corresponding to activation of icon 832, computer system 800 displays, via display 802, second media window 830, including representation 830A of the second media. First media window 820 and second media window 830 are windows of the same application (e.g., a media viewer application and/or a content browser). At FIG. 8E, computer system 800 has shifted first media window 820 out of the foreground of the user interface based on second media window 830, and therefore representation 830A is in the foreground of the user interface, as indicated by the bold border around second media window 830. Some portions (e.g., the sky and the subject's jacket) of the second media have a target brightness that is above the standard range of brightness and other portions (e.g., the mountains) of the second media have a target brightness that is within the standard range of brightness. At FIG. 8E, because second media window 830 is in the foreground of the user interface, computer system 800 displays the portions of representation 830A of the second media with target brightnesses above the standard range of brightness at brightnesses that are above the standard range of brightness (e.g., the HDR image is output as HDR). At FIG. 8E, although first media window 820 is not in the foreground of the user interface, computer system 800 displays the portions of representation 820A of the first media with target brightnesses above the standard range of brightness at brightnesses that are above the standard range of brightness (e.g., the HDR image is output as HDR) because a window (e.g., second media window 830) of the same application (e.g., the media view application and/or the content browser) as first media window 820 is in the foreground and no windows overlap first media window 820. At FIG. 8E, cursor 804 is overlaid on representation 820A. Because cursor 804 is not overlaid on content that is displayed with a brightness that is above the standard range of brightness, computer system 800 displays cursor 804 with a lower brightness than if cursor 804 was overlaid on content displayed with a brightness above the standard range of brightness. For example, because cursor 804 is not overlaid on portions of representation 820A that are displayed in HDR, computer system 800 displays cursor 804 as SDR and/or non-HDR. Thus, computer system 800 displays cursor 804 of FIG. 8E with a higher brightness and/or with a higher dynamic range as compared to indication 814 of FIG. 8A. Because playback control 820B, playback control 830B, metadata text 820C, and metadata text 830C are overlaid on content that is displayed with a brightness that is above the standard range of brightness, computer system 800 displays the elements with a higher brightness (e.g., HDR) than if the elements were not overlaid on content displayed with a brightness above the standard range of brightness. At FIG. 8D, computer system 800 detects a user input corresponding to activation of icon 832 via cursor 804.

At FIG. 8F, computer system 800 has detected a user input corresponding to a request to move cursor 804 up and, in response, computer system 800 moves cursor 804 up in the user interface, as shown in FIG. 8F. At FIG. 8E, cursor 804 continues to be overlaid on representation 820A. Because cursor 804 is overlaid on content that is displayed with a brightness that is above the standard range of brightness, computer system 800 displays cursor 804 with a higher brightness than if cursor 804 was not overlaid on content displayed with a brightness above the standard range of brightness. For example, because cursor 804 is overlaid on portions of representation 820A that are displayed in HDR, computer system 800 displays cursor 804 as HDR. Thus, computer system 800 displays cursor 804 of FIG. 8F with a higher brightness and/or with a higher dynamic range as compared to cursor 804 of FIG. 8E. Because playback control 820B, playback control 830B, metadata text 820C, and metadata text 830C are overlaid on content that is displayed with a brightness that is above the standard range of brightness, computer system 800 displays the elements with a higher brightness (e.g., HDR) than if the elements were not overlaid on content displayed with a brightness above the standard range of brightness. In some embodiments, this enables the user to better distinguish cursor 804, playback control 820B, playback control 830B, metadata text 820C, and metadata text 830C from the HDR content on which the elements are overlaid.

At FIG. 8G, computer system 800 has detected a user input corresponding to selection of document window 810. At FIG. 8G, in response to detecting the user input corresponding to the selection of document window 810, computer system 800 has shifted second media window 830 out of the foreground of the user interface and document window 810 into the foreground of the user interface, as indicated by the bold border around document window 810. At FIG. 8G, because second media window 830 is no longer in the foreground of the user interface, computer system 800 displays representation 830A and representation 820A with brightnesses that are within the standard range of brightness. For example, computer system 800 displays the portions of representation 820A of the first media with target brightnesses above the standard range of brightness at brightnesses that are within the standard range of brightness (e.g., the HDR image is displayed as SDR and/or not HDR). For another example, computer system 800 displays the portions of representation 830A of the second media with target brightnesses above the standard range of brightness at brightnesses that are within the standard range of brightness (e.g., the HDR image is displayed as SDR and/or not HDR). Because playback control 820B, playback control 830B, metadata text 820C, and metadata text 830C are overlaid on content that is displayed with a brightness that is within the standard range of brightness, computer system 800 displays the elements with a lower brightness (e.g., SDR and/or non-HDR) than if the elements were overlaid on content displayed with a brightness above the standard range of brightness. Thus, computer system 800 has reduced the brightnesses and dynamic ranges of representation 820A of the first media and of representation 830A of the second media.

At FIG. 8H, computer system 800 detects a user input corresponding to selection and movement (e.g., dragging and/or repositioning) of second media window 830 to partially overlap first media window 820. At FIG. 8H, in response to detecting the user input corresponding to selection of second media window 830, computer system 800 has shifted second media window 830 into the foreground of the user interface and document window 810 out of the foreground of the user interface, as indicated by the bold border around second media window 830. At FIG. 8H, because second media window 830 is in the foreground of the user interface, computer system 800 displays the portions of representation 830A of the second media with target brightnesses above the standard range of brightness at brightnesses that are above the standard range of brightness (e.g., the HDR image is output as HDR). Although first media window 820 is a window of the same application (e.g., the media view application and/or the content browser) as another window (e.g., second media window 830) that is in the foreground, computer system 800 displays the portions of representation 820A of the first media with target brightnesses above the standard range of brightness at brightnesses that are within the standard range of brightness (e.g., the HDR image is output as SDR and/or non-HDR) because a window (e.g., second media window 830) overlaps first media window 820 and/or overlaps representations 820A of the first media. Because playback control 820B and metadata text 820C are overlaid on content that is displayed with a brightness that is within the standard range of brightness, computer system 800 displays the elements with a lower brightness (e.g., SDR and/or non-HDR). Because playback control 830B and metadata text 830C are overlaid on content that is displayed with a brightness that is above the standard range of brightness, computer system 800 displays the elements with a higher brightness (e.g., SDR and/or non-HDR).

FIGS. 8I-8K illustrate example user interfaces using computer system 860. In some embodiments, the same techniques described with respect to computer system 860 applies equally to computer system 800. At FIG. 8I, computer system 860 is displaying, via display 862, message conversation 864, which includes messages from a plurality of users, including representation 820A of the first image. While representation 820A of the first image is displayed as part of message conversation 864 (e.g., in line with messages of message conversation 864), computer system 860 displays representation 820A with the standard range of brightness (e.g., the HDR image is output as SDR and/or non-HDR). At FIG. 8I, computer system 862 has received an incoming message and, in response, displays notification 812C corresponding to the incoming message, as shown in FIG. 8I. Because notification 812C is not overlaid on content that is displayed with a brightness that is above the standard range of brightness, computer system 800 displays notification 812C with a lower brightness than if notification 812C was overlaid on content displayed with a brightness above the standard range of brightness. For example, because notification 812C is not overlaid on content that is displayed in HDR, computer system 800 displays notification 812C as SDR and/or non-HDR. At FIG. 8I, computer system 860 detects user input 850A (e.g., a tap input and/or a tap-and-hold input) directed to representation 820A.

At FIG. 8J, in response to detecting user input 850A directed to representation 820A, computer system 860 displays representation 820A in an expanded state (e.g., enlarged and/or full screen). Because representation 820A is displayed in an expanded state, computer system 860 displays representation 820A with a brightness that is above the standard range of brightness (e.g., the HDR image is output as HDR). At FIG. 8J, because notification 812C is now overlaid on content that is displayed with a brightness that is above the standard range of brightness, computer system 800 increases the brightness of notification 812C. For example, because notification 812C is overlaid on content that is displayed in HDR, computer system 800 displays notification 812C in HDR. Thus, computer system 800 displays notification 812C of FIG. 8J with a higher brightness and/or with a higher dynamic range as compared to notification 812C of FIG. 8I. At FIG. 8J, computer system 860 detects user input (e.g., 850B and/or 850C). In response to detecting the user input (e.g., 850B) and in accordance with a determination that the user input includes selection of (e.g., a tap input on and/or a press-and-hold on) notification 812C, computer system 860 replaces display of representation 820A with display of a message conversation corresponding to notification 812C. In response to detecting the user input (e.g., 850C) and in accordance with a determination that the user input includes dismissal of (e.g., an upward swipe input on and/or a double-tap input on) notification 812C, computer system 860 dismisses notification 812C by ceasing to display notification 812C and maintains display of representation 820A, as shown in FIG. 8K. At FIG. 8K, because representation 820A remains displayed in an expanded state, computer system 860 continues to display representation 820A with a brightness that is above the standard range of brightness (e.g., the HDR image is output as HDR).

FIG. 9 is a flow diagram illustrating a method for modifying the brightness of user interface objects, in accordance with some embodiments. Method 900 is performed at a computer system (e.g., 100, 300, 500, 600, 800, and/or 860) (e.g., a smartphone, a tablet computer, a laptop computer, a desktop computer, and/or a head mounted device (e.g., a head mounted augmented reality and/or extended reality device)) that is in communication with a display generation component (e.g., 802 and/or 862) (e.g., a display controller, a touch-sensitive display system, a monitor, and/or a head mounted display system). In some embodiments, the computer system is also configured to communicate with one or more input devices (e.g., a touch-sensitive surface, a keyboard, a controller, and/or a mouse). In some embodiments, the computer system uses one or more display generation components for displaying content. Some operations in method 900 are, optionally, combined, the orders of some operations are, optionally, changed, and some operations are, optionally, omitted.

As described below, method 900 provides an intuitive way for modifying the brightness of user interface objects. The method reduces the cognitive burden on a user for modifying the brightness of user interface objects, thereby creating a more efficient human-machine interface. For battery-operated computing devices, enabling a user to modify the brightness of user interface objects faster and more efficiently conserves power and increases the time between battery charges.

The computer system (e.g., 800 and/or 860) detects (902) an event (e.g., a sequence of one or more inputs detected via one or more input devices in communication with the computer system and/or a system event, such as an event that corresponds to a notification) (e.g., input at FIG. 8A, input at FIG. 8B, input at FIG. 8D, and/or input 850A at FIG. 8I) corresponding to a request to display a user interface (e.g., 820 and/or 830) (e.g., a user interface of a first application, a window in a desktop environment, and/or visual media) that has an appearance that is based on the event.

In response to detecting the event (e.g., input at FIG. 8A, input at FIG. 8B, input at FIG. 8D, and/or input 850A at FIG. 8I), the computer system (e.g., 800 and/or 860) displays (904), via the display generation component (e.g., 802 and/or 862), a user interface (e.g., 820 and/or 830) that has an appearance that is based on the event, wherein the user interface includes first content (e.g., 820A and/or 830A) (e.g., an image, a video, and/or a visual object of the user interface) that includes at least a portion that has a target brightness that is outside of a standard range of brightness for the display generation component (e.g., above a predefined brightness threshold and/or a respective brightness level) (e.g., the first content is high-dynamic-range (HDR) content, wide dynamic range content, extended dynamic range content, and/or expanded dynamic range content). Displaying the user interface (e.g., 820 and/or 830) that has an appearance that is based on the event includes: in accordance with a determination that the first content (e.g., 820A and/or 830A) (e.g., an image, a video, and/or a visual object of an application user interface) is in a foreground (e.g., 820A in FIG. 8B, 830A in FIG. 8E, and/or 820A in FIG. 8J) (e.g., the user interface (of which the first content is a part of) is in the foreground and/or is the most forward user interface), displaying (906), via the display generation component (e.g., 802 and/or 862), the first content (e.g., 820A and/or 830A) with a brightness that is above the standard range of brightness for the display generation component (e.g., 820A in FIG. 8B, 830A in FIG. 8E, and/or 820A in FIG. 8J) (e.g., at the target brightness and/or at a brightness that is above the standard range of brightness). In some embodiments, the first content is in the foreground when the user interface is in the foreground of a workspace, a desktop, and/or an extended reality user interface. Displaying the user interface (e.g., 820 and/or 830) that has an appearance that is based on the event includes: in accordance with a determination that the first content (e.g., 820A and/or 830A) is not in the foreground (e.g., 820A in FIG. 8C and/or 830A in FIG. 8G) (e.g., the user interface (of which the first content is a part of) is in the background and/or is not the most forward user interface element), displaying (908), via the display generation component (e.g., 802 and/or 862), the first content (e.g., 820A and/or 830A) with a brightness that is within the standard range of brightness for the display generation component (e.g., 820A in FIG. 8C and/or 830A in FIG. 8G) (e.g., the brightness of the first content is below the target brightness). In some embodiments, the first content is not in the foreground and/or is in the background when the user interface is not in the foreground and/or is in the background of a workspace, a desktop, and/or an extended reality user interface. In some embodiments, detecting the event includes receiving a notification, detecting a request to switch to displaying the first content, detecting a request to open the first content, detecting a request to close content other than the first content (e.g., that reveals the first content), detecting a request to change an order (e.g., a z-order) of content (e.g., that reveals the first content), and/or detecting a request to enlarge a display area of the user interface (e.g., maximize a window, which reveals the first content). In some embodiments, detecting the event includes detecting a user input, detecting a gesture, detecting a touch input, detecting a cursor input, detecting an air gesture, detecting a button input, detecting a voice input, detecting an input corresponding to activation of (e.g., tap input on and/or mouse click on) an application icon (e.g., to start the application and/or to bring the application to the foreground), and/or detecting an input corresponding to activation of a content icon (e.g., to display the first content and/or to bring the first content to the foreground). Displaying the first content with a brightness that is based on whether the first content is in the foreground or not enables the computer system to provide high-quality and bright visuals for content that the user is likely currently accessing without making contents on the entire display unnecessarily bright. Further, limiting the content that is displayed with a brightness that is above the standard range of brightness enables the computer system to limit power usage, thereby conserving battery charge. Thus, the computer system displays more foreground HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, while displaying the user interface (e.g., 820 and/or 830) that has an appearance that is based on the event, the computer system (e.g., 800 and/or 860) detects a second event (e.g., input at FIG. 8B, 8C, and/or 8D) corresponding to a request to move the first content (e.g., 820A and/or 830A) into the foreground or out of the foreground. In response to detecting the second event (e.g., input at FIG. 8B, 8C, and/or 8D) (e.g., optionally in a different order), the computer system (e.g., 800 and/or 860) moves the first content into the foreground or out of the foreground (e.g., 820A in FIGS. 8C and 8D, and/or 830A in FIG. 8E) and/or changes a brightness (e.g., increasing the brightness to be above the standard range of brightness (e.g., in the HDR range of brightness) or reducing the brightness to be in the standard range of brightness) of the first content (e.g., 820A in FIGS. 8C and 8D). In some embodiments, detecting the second event includes receiving a notification, detecting a request to bring forward (e.g., in the z-order and/or to the foreground) the user interface that includes the first content, detecting a request to move backwards (e.g., in the z-order) the user interface that includes the first content, detecting a request to open a new user interface (e.g., that moves the first content out of the foreground), detecting a request to change an order (e.g., a z-order) of content, and/or detecting a user input (e.g., a gesture, a touch input, a cursor input, a button input, a voice input, and/or an air gesture). Conditionally varying the brightness of the first content as the first content moves into and out of the foreground enables the computer system to provide high-quality and bright visuals for content that the user is likely currently accessing without making contents on the entire display unnecessarily bright. Further, limiting the content that is displayed with a brightness that is above the standard range of brightness enables the computer system to limit power usage, thereby conserving battery charge. Thus, the computer system displays foreground HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the second event (e.g., input at FIG. 8C) corresponds to a request to move the first content (e.g., 820A) into the foreground. In some embodiments, the request to move the first content into the foreground includes a cursor input (e.g., click) corresponding to (e.g., on) the first content. In some embodiments, the request to move the first content into the foreground includes an air gesture, a cursor input, a touch input, and/or an air gesture. In some embodiments, changing the brightness of the first content (e.g., 820A) in response to detecting the second event (e.g., input at FIG. 8C) includes increasing the brightness of the first content (e.g., 820A) to be above the standard range of brightness (e.g., in the HDR range of brightness) for the display generation component (e.g., increasing the brightness of the at least a portion of the first content to the target brightness). Thus, in some embodiments, in accordance with a determination that the second event corresponds to a request to move the first content into the foreground, the computer system increases the brightness of the first content so that the brightness of the first content is above the standard range of brightness for the display generation component. Displaying the first content with a brightness that is above the standard range of brightness when the first content is in the foreground enables the computer system to provide high-quality and bright visuals for content that the user is likely currently accessing and also provides the user with visual feedback about which content is in the foreground, thereby providing improved visual feedback. Thus, the computer system displays HDR content that moves into the foreground using high-quality and bright visuals by using a brightness that is above the standard range of brightness for the display generation component, while conserving energy (such as battery power) by displaying HDR content that moves into the background with a brightness that is within the standard range of brightness for the display generation component.

In some embodiments, the second event (e.g., input at FIG. 8B) corresponds to a request to move the first content (e.g., 820A) out of the foreground (e.g., into the background because, for example, different content has moved into the foreground). In some embodiments, changing the brightness of the first content (e.g., 820A) in response to detecting the second event (e.g., input at FIG. 8B) includes decreasing the brightness of the first content (e.g., 820A) to be within the standard range of brightness (e.g., not in the HDR range of brightness) for the display generation component (e.g., 802) (e.g., decreasing the brightness of the at least a portion of the first content to below the target brightness and/or to be within the standard range of brightness for the display generation component). Thus, in some embodiments, in accordance with a determination that the second event corresponds to a request to move the first content out of the foreground, the computer system decreases the brightness of the first content so that the brightness of the first content is within the standard range of brightness for the display generation component. Displaying the first content with a brightness that is within the standard range of brightness when the first content is not in the foreground enables the computer system to reduce power usage for content that the user is likely currently not accessing and also provides the user with visual feedback about which content is not in the foreground, thereby providing improved visual feedback. Thus, the computer system displays HDR content that moves into the foreground using high-quality and bright visuals by using a brightness that is above the standard range of brightness for the display generation component, while conserving energy (such as battery power) by displaying HDR content that moves into the background with a brightness that is within the standard range of brightness for the display generation component.

In some embodiments, the user interface (e.g., 820) corresponds to a first application and a second user interface (e.g., 830), different from the user interface (e.g., 820), corresponds to the first application. In some embodiments, the second user interface (e.g., 830) includes second content (e.g., 830A) that includes at least a portion that has a target brightness that is outside of the standard range of brightness for the display generation component (e.g., above a predefined brightness threshold and/or a respective brightness level) (e.g., the second content is high-dynamic-range (HDR) content, wide dynamic range content, extended dynamic range content, and/or expanded dynamic range content). In some embodiments, the computer system (e.g., 800) concurrently displays (e.g., as in FIGS. 8E and 8F), via the display generation component (e.g., 802): the user interface (e.g., 820) in the foreground with the first content (e.g., 820A) (e.g., a first photo) displayed with a brightness that is above the standard range of brightness for the display generation component (e.g., 802) and the second user interface (e.g., 830) (e.g., in the foreground or in the background) with the second content (e.g., 830A) (e.g., a second photo, different from the first photo) displayed with a brightness that is above the standard range of brightness for the display generation component (e.g., 802), wherein the second user interface (e.g., 830) does not overlap the user interface (e.g., as shown in FIGS. 8E and 8F) (and, optionally, the user interface does not overlap the second user interface). In some embodiments, two user interfaces (e.g., windows and/or elements, such as the user interface and the second user interface) of the same application can be in the foreground and can both be displayed with a brightness that is above the standard range of brightness for the display generation component when the two user interfaces are not overlapping. In some embodiments, when the two user interfaces of the same application overlap, the user interface that is on top (e.g., the most forward user interface in the z-plane) is displayed with a brightness that is above the standard range of brightness for the display generation component and the other user interface is displayed with a brightness that is within the standard range of brightness for the display generation component. Displaying two different non-overlapping user interfaces of the same application with content displayed with a brightness that is above the standard range of brightness for the display generation component enables the computer system to provide high-quality and bright visuals for content from an application that the user is likely currently accessing and also provides the user with visual feedback about which application has content that is in the foreground, thereby providing improved visual feedback. Thus, the computer system displays HDR content from two non-overlapping foreground user interfaces using high-quality and bright visuals by using a brightness that is above the standard range of brightness for the display generation component, while conserving energy (such as battery power) by displaying HDR content that is in the background with a brightness that is within the standard range of brightness for the display generation component.

In some embodiments, the determination of whether the user interface (e.g., 820) is in the foreground (e.g., or not in the foreground) is based on whether a system overlay (e.g., a share user interface for sharing content with other users and/or a control user interface for changing one or more settings of the computer system) is being concurrently displayed with the user interface (e.g., 820). In some embodiments, the user interface is not in the foreground when a system overlay is concurrently being displayed with the user interface. Determining the foreground/background state of the user interface based on whether a system overlay is currently being displayed enables the computer system to display contents of the user interface with a brightness that is based on whether the system overlay is being displayed, thereby providing the user with visual feedback about whether a system overlay is being displayed. Thus, the computer system conserves energy (such as battery power) by displaying HDR content with a brightness that is within the standard range of brightness for the display generation component when a system overlay is currently being displayed.

In some embodiments, the computer system (e.g., 800 and/or 860) displays (e.g., while displaying the first content with a brightness that is above the standard range of brightness for the display generation component), via the display generation component (e.g., 802 and/or 862), one or more elements (e.g., 804, 812A, 814, 820B and/or 820C). In some embodiments, displaying the one or more elements includes: in accordance with a determination that the one or more elements (e.g., 804, 812A, 814, 820A, 820B, and/or 820C) are at least partially (e.g., less than all or all) overlaid on a portion of content (e.g., a portion of the first content, a portion of the second content, and/or a portion of other content), wherein the portion of content is displayed with a brightness that is within the standard range of brightness for the display generation component, displaying the one or more elements with a first brightness (e.g., 804 at FIGS. 8A-8E, 812A and 814 at FIG. 8A, 820B and 820C at FIGS. 8C, 8G, and 8H) (e.g., a brightness that is within the standard range of brightness for the display generation component or a brightness that is not at the top of the standard range of brightness for the display generation component). In some embodiments, displaying the one or more elements (e.g., 804, 812A, 814, 820B and/or 820C) includes: in accordance with a determination that the one or more elements (e.g., 804, 812B, 814, 820B and/or 820C) are at least partially overlaid on a portion of content, wherein the portion of content is displayed with a brightness that is above the standard range of brightness for the display generation component, displaying the one or more elements with a second brightness (e.g., 804 at FIG. 8F, 812B at FIG. 8D, 814 at FIG. 8D, 820B at FIGS. 8B and 8E, and/or 820C at FIGS. 8B and 8E) (e.g., a brightness that is above the standard range of brightness for the display generation component or a brightness that is at the top of the standard range of brightness for the display generation component) that is brighter than the first brightness. In some embodiments, the content is the first content that includes at least a portion that has a target brightness that is outside of the standard range of brightness for the display generation component. Displaying elements with a brightness that is based on whether the element is displayed over content that is displayed with a brightness within or above the standard range of brightness for the display generation component enables the computer system to adjust the brightness of the element relative to the content, thereby increasing the visibility of the element and helping to avoid the color of the element from appearing washed out. Further, displaying the element with a lower brightness when displayed over content with a brightness that is within the standard range of brightness enables the computer system to limit power usage, thereby conserving battery charge. Thus, the computer system displays foreground HDR content and one or more elements overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the one or more elements include a cursor (e.g., 804) (e.g., a mouse cursor that tracks movement of a mouse or touch movement on a trackpad, a cursor that tracks a gaze of a user, and/or a pointer that indicates a selection location). Conditionally increasing and decreasing the brightness of a cursor as the cursor is displayed over content with varying brightnesses enables the computer system to increase the visibility of the cursor, to prevent the cursor from appearing washed out, and to conserve battery charge. Thus, the computer system displays foreground HDR content and a cursor overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the one or more elements include a notification (e.g., 812A and/or 812B) (e.g., a notification displayed in response to receiving data, a pop-up alert generated based on detection of an event, and/or a message displayed that is unrelated to the current activity on the computer). In some embodiments, the notification indicates that an instant message has been received and optionally includes a name of the sender of the instant message and/or content of the instant message. In some embodiments, the notification indicates a battery state (e.g., percentage and/or low battery) of the computer system. Conditionally increasing and decreasing the brightness of a notification as the notification is displayed over content with varying brightnesses enables the computer system to increase the visibility of the notification, to prevent the notification from appearing washed out, and to conserve battery charge. Thus, the computer system displays foreground HDR content and a notification overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the computer system (e.g., 800) is configured to communicate with one or more input devices and the one or more elements include a system user interface that includes one or more options configured to change one or more system settings. In some embodiments, while displaying the system user interface (e.g., via 802), the computer system (e.g., 800) detects, via the one or more input devices, an input corresponding to activation of (e.g., a tap input or other selection input directed to) an option of the one or more options. In response to detecting the input corresponding to activation of the option of the one or more options, the computer system (e.g., 800) changes a system setting that corresponds to the option (e.g., enabling/disabling a communication technique (e.g., cellular communication, WiFi communication, and/or communication via a short-range communication radio), configuring (e.g., setting, locking, or unlocking) a display orientation of the computer system, and/or changing a system volume of the computer system). Conditionally increasing and decreasing the brightness of a system user interface as the system user interface is displayed over content with varying brightnesses enables the computer system to increase the visibility of the system user interface, to prevent the system user interface from appearing washed out, and to conserve battery charge. Thus, the computer system displays foreground HDR content and a system user interface overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the one or more elements include an indication (e.g., 814) corresponding to a digital assistant. In some embodiments, the indication corresponding to the digital assistant is an indication that the digital assistant is receiving audio (e.g., a query spoken by the user). In some embodiments, the indication corresponding to the digital assistant is a result of a received query. In some embodiments, the digital assistant responds to queries, provides suggestions, and/or performs operations. In some embodiments, the digital assistant uses spoken queries, gaze-based controls, gesture-based controls, and/or a natural-language user interface to receive queries. Conditionally increasing and decreasing the brightness of an indication of a digital assistant as the indication of the digital assistant is displayed over content with varying brightnesses enables the computer system to increase the visibility of the indication of the digital assistant, to prevent the indication of the digital assistant from appearing washed out, and to conserve battery charge. Thus, the computer system displays foreground HDR content and an indication corresponding to a digital assistant overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the one or more elements include textual information (e.g., 820C) (e.g., alphanumeric text). In some embodiments, the textual information is based on media (e.g., photo and/or video) metadata. In some embodiments, the content is media (e.g., a photo and/or video) and the media metadata about the media is overlaid on the media. Conditionally increasing and decreasing the brightness of text as the text is displayed over content with varying brightnesses enables the computer system to increase the visibility of the text, to prevent the text from appearing washed out, and to conserve battery charge. Thus, the computer system displays foreground HDR content and text overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the computer system (e.g., 800) is configured to communicate with one or more input devices and the one or more elements include a control option (e.g., 820B) (e.g., an option to navigate among media, an option to delete a media, an option to change a playback state of a media). While displaying the control option (e.g., 820B as in FIG. 8B) overlaid on a portion of content (e.g., media, such as a photo and/or video), the computer system (e.g., 800) detects, via the one or more input devices, an input corresponding to activation of (e.g., a tap input directed to and/or a selection using a cursor) the control option (e.g., 820B). In response to detecting the input corresponding to activation of the control option, the computer system (e.g., 800) performs an operation (e.g., navigating to a next or previous media, initiating a process to delete the media, and/or changing a playback state of the media) corresponding to the control option (e.g., 820B). Conditionally increasing and decreasing the brightness of a control option that is displayed over content with varying brightnesses enables the computer system to increase the visibility of the control option, to prevent the control option from appearing washed out, and to conserve battery charge. Thus, the computer system displays foreground HDR content and a control option overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the determination that the one or more elements (e.g., 804) are at least partially (e.g., less than all or all) overlaid on a portion of content (e.g., a portion of the first content, a portion of the second content, and/or a portion of other content) displayed with a brightness that is within the standard range of brightness for the display generation component includes a determination that an area adjacent to (e.g., surrounding and/or directly next to) the one or more elements (e.g., 804) (e.g., the area adjacent to a respective element) is displayed with a brightness that is within the standard range of brightness for the display generation component (e.g., as in 804 at FIG. 8E) and the determination that the one or more elements (e.g., 804) are at least partially (e.g., less than all or all) overlaid on a portion of content (e.g., a portion of the first content, a portion of the second content, and/or a portion of other content) displayed with a brightness that is above the standard range of brightness for the display generation component includes a determination that the area adjacent to (e.g., surrounding and/or directly next to) the one or more elements (e.g., the area adjacent to a respective element) is displayed with a brightness that is above the standard range of brightness for the display generation component (e.g., as in 804 at FIG. 8F). In some embodiments, a brightness of a respective element is based on whether the area directly around and/or the area occluded by the respective element is displayed with a brightness that is within the standard range of brightness for the display generation component. Displaying elements with a brightness that is based on whether the element is displayed over content that is displayed with a brightness within or above the standard range of brightness for the display generation component enables the computer system to adjust the brightness of the element relative to the content, thereby increasing the visibility of the element and helping to avoid the color of the element from appearing washed out. Further, displaying the element with a lower brightness when displayed over content with a brightness that is within the standard range of brightness enables the computer system to limit power usage, thereby conserving battery charge. Thus, the computer system displays foreground HDR content and one or more elements overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the computer system (e.g., 800 and/or 860) displays, via the display generation component (e.g., 802 and/or 862), a representation (e.g., 820A at FIGS. 8I-8K) of an image (e.g., photo and/or a drawing), wherein the representation of the image includes at least a first portion that corresponds to a portion of the image that has a target brightness that is outside of the standard range of brightness for the display generation component (e.g., above a predefined brightness threshold and/or a respective brightness level) (e.g., the first content is high-dynamic-range (HDR) content, wide dynamic range content, extended dynamic range content, and/or expanded dynamic range content), including: in accordance with a determination that the representation of the image is displayed in an expanded state (e.g., 820A at FIGS. 8J-8K) (e.g., full screen and/or not inline in (e.g., as part of) a conversation in which the image was communicated (e.g., sent or received)), displaying, via the display generation component, the representation of the image with a brightness that is above the standard range of brightness for the display generation component (e.g., at the target brightness and/or at a brightness that is above the standard range of brightness); and in accordance with a determination that the representation of the image is not displayed in the expanded state (e.g., 820A at FIG. 8I) (e.g., is not full screen, is displayed in a minimized state, is displayed in a reduced state, and/or is displayed inline in (e.g., as part of) a conversation in which the image was communicated (e.g., sent or received)), displaying, via the display generation component, the representation of the image with a brightness that is within the standard range of brightness for the display generation component. In some embodiments, when the representation of the image is displayed as part of a message conversation (e.g., instant message conversation and/or email message conversation) without being in the expanded state, the computer system displays the image using the standard range of brightness for the display generation component (e.g., not HDR) and when the representation of the image is displayed in the expanded state (e.g., based on the representation that is being activated while displayed as part of the message conversation) and not displayed as part of the message conversation, the computer system displays the image using a brightness that is above the standard range of brightness for the display generation component (e.g., HDR). Conditionally displaying a representation of an image with varying brightnesses based on whether the representation is expanded or not expanded enables the computer system to display the image with more realistic colors and brightness while expanded and conserve power while the image is not expanded. Thus, the computer system displays HDR content that is in an expanded state using high-quality and bright visuals by using a brightness that is above the standard range of brightness for the display generation component, while conserving energy (such as battery power) by displaying HDR content that is not in an expanded state (e.g., is minimized) with a brightness that is within the standard range of brightness for the display generation component.

In some embodiments, the computer system (e.g., 800 and/or 860) detects a brightness change event. In some embodiments, detecting the brightness change event includes detecting a change in a power state of the computer system (e.g., transition into or out of a low-power state), detecting a change in ambient brightness (e.g., an increase or decrease in ambient brightness), and/or detecting a user input (e.g., a touch input, a cursor input, a gesture, a voice input, and/or an air gesture). In response to detecting the brightness change event, the computer system (e.g., 800 and/or 860) changes (e.g., decreasing or increasing) a system brightness level of the display generation component (e.g., 802 and/or 862) based on the brightness change event and/or changes (e.g., increasing or decreasing) a headroom for brightness above the standard range of brightness of the display generation component (e.g., 802 and/or 862) (e.g., reducing the HDR headroom, such as from 4×, 3.5×, 3.3×, or 3× to 2.5×, 2.2×, 2×, or 1.8×). In some embodiments, the computer system detects a brightness request to increase the system brightness level of the display generation component and, in response, increases the system brightness level of the display generation component based on the brightness change event and increases the headroom for brightness above the standard range of brightness of the display generation component (e.g., increasing the HDR headroom, such as from 2.5×, 2.2×, 2×, or 1.8× to 4×, 3.5×, 3.3×, or 3×). In some embodiments, the brightness change event is based on a detected ambient light measurement. In some embodiments, the brightness change event is based on user input. In some embodiments, the computer system detects a brightness change event to decrease the system brightness level of the display generation component and, in response, decreases the system brightness level of the display generation component based on the brightness change event and increases or decreases the headroom for brightness above the standard range of brightness of the display generation component (e.g., increasing the HDR headroom, such as from 2.5×, 2.2×, 2×, or 1.8× to 4×, 3.5×, 3.3×, or 3×). In some embodiments, the brightness change event is based on a detected ambient light measurement. In some embodiments, the brightness change event is based on user input. In some embodiments, headroom (e.g., HDR headroom) is a multiple of the maximum brightness of the standard range of the display generation component. In some embodiments, headroom (e.g., HDR headroom) is the ratio between the maximum brightness that the display is currently configured to produce to the brightness of white (e.g., in the standard range of brightness). In some embodiments, a display that has an HDR headroom of 1 (e.g., 1×) does not display images with a brightness that is above the standard range of brightness (e.g., the display displays content in SDR, rather than HDR). Changing a headroom for brightness above the standard range of brightness when the system brightness level changes enables the computer system to avoid providing unnecessarily bright content, thereby improving the man-machine interface, and conserves battery charge. Thus, the computer system displays foreground HDR content using high-quality and bright visuals by using a brightness that is above the standard range of brightness for the display generation component, while conserving energy (such as battery power) by displaying background HDR content with a brightness that is within the standard range of brightness for the display generation component.

In some embodiments, the change of the headroom (e.g., of display 802 and/or 862) has a non-linear relationship to the change in system brightness level. In some embodiments, a corresponding increase of the headroom has a non-linear relationship (e.g., same as or different from the reduction of the headroom) to the increase in system brightness level. In some embodiments, a corresponding decrease of the headroom has a non-linear relationship (e.g., same as or different from the reduction of the headroom) to the decrease in system brightness level. In some embodiments, a percentage change (e.g., reduction or increase) in the brightness of the system brightness level does not result in the same percentage change (e.g., reduction or increase) in the headroom. Using a non-linear relationship between the rate at which the headroom and the system brightness level are modified enables the computer system to more quickly increase or decrease the brightness levels for brightness above the standard range of brightness to conserve battery charge and/or to more quickly ramp up or ramp down the brightness level above the standard range of brightness to provide more realistic and bright content, thereby improving the man-machine interface. Thus, the computer system displays foreground HDR content and one or more elements overlaid on the HDR content using high-quality and bright visuals by using a brightness that is above the standard range of brightness for the display generation component, while conserving energy (such as battery power) by displaying background HDR content with a brightness that is within the standard range of brightness for the display generation component.

Note that details of the processes described above with respect to method 900 (e.g., FIG. 9) are also applicable in an analogous manner to the methods described above. For example, method 900 optionally includes one or more of the characteristics of the various methods described above with reference to method 700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how to control the brightness of user interface objects. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to control the brightness of user interface objects. Accordingly, use of such personal information data enables users to have calculated control of what user interface objects are brightened. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of brightening user interface objects, the present technology can be configured to allow users to select to “opt in” or “opt out” of participation in the collection of personal information data during registration for services or anytime thereafter. In another example, users can select not to provide mood-associated data for brightening user interface objects. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user interface objects are brightened by inferring preferences based on non-personal information data or a bare minimum amount of personal information, such as the content being requested by the device associated with a user, other non-personal information available to the user interface object brightening services, or publicly available information.

What is claimed is:

1. A computer system configured to communicate with a display generation component, comprising:
one or more processors; and
memory storing one or more programs configured to be executed by the one or more processors, the one or more programs including instructions for:
detecting an event corresponding to a request to display a user interface that has an appearance that is based on the event; and
in response to detecting the event, displaying, via the display generation component, a user interface that has an appearance that is based on the event, wherein the user interface includes first content that includes at least a portion that has a target brightness that is outside of a standard range of brightness for the display generation component, including:
in accordance with a determination that the first content is in a foreground, displaying, via the display generation component, the first content with a brightness that is above the standard range of brightness for the display generation component; and
in accordance with a determination that the first content is not in the foreground, displaying, via the display generation component, the first content with a brightness that is within the standard range of brightness for the display generation component.

2. The computer system of claim 1, the one or more programs further including instructions for:
while displaying the user interface that has an appearance that is based on the event, detecting a second event corresponding to a request to move the first content into the foreground or out of the foreground; and
in response to detecting the second event:
moving the first content into the foreground or out of the foreground; and
changing a brightness of the first content.

3. The computer system of claim 2, wherein:
the second event corresponds to a request to move the first content into the foreground; and
changing the brightness of the first content in response to detecting the second event includes increasing the brightness of the first content to be above the standard range of brightness for the display generation component.

4. The computer system of claim 2, wherein:
the second event corresponds to a request to move the first content out of the foreground; and
changing the brightness of the first content in response to detecting the second event includes decreasing the brightness of the first content to be within the standard range of brightness for the display generation component.

5. The computer system of claim 1:
wherein:
the user interface corresponds to a first application;
a second user interface, different from the user interface, corresponds to the first application; and
the second user interface includes second content that includes at least a portion that has a target brightness that is outside of the standard range of brightness for the display generation component; and
the one or more programs further include instructions for:
concurrently displaying, via the display generation component:
the user interface in the foreground with the first content displayed with a brightness that is above the standard range of brightness for the display generation component; and
the second user interface with the second content displayed with a brightness that is above the standard range of brightness for the display generation component, wherein the second user interface does not overlap the user interface.

6. The computer system of claim 1, wherein the determination of whether the user interface is in the foreground is based on whether a system overlay is being concurrently displayed with the user interface.

7. The computer system of claim 1, the one or more programs further including instructions for:
displaying, via the display generation component, one or more elements, including:
in accordance with a determination that the one or more elements are at least partially overlaid on a portion of content, wherein the portion of content is displayed with a brightness that is within the standard range of brightness for the display generation component, displaying the one or more elements with a first brightness; and
in accordance with a determination that the one or more elements are at least partially overlaid on a portion of content, wherein the portion of content is displayed with a brightness that is above the standard range of brightness for the display generation component, displaying the one or more elements with a second brightness that is brighter than the first brightness.

8. The computer system of claim 7, wherein the one or more elements include a cursor.

9. The computer system of claim 7, wherein the one or more elements include a notification.

10. The computer system of claim 7, wherein the computer system is configured to communicate with one or more input devices and the one or more elements include a system user interface that includes one or more options configured to change one or more system settings, the one or more programs further including instructions for:
while displaying the system user interface, detecting, via the one or more input devices, an input corresponding to activation of an option of the one or more options; and
in response to detecting the input corresponding to activation of the option of the one or more options, changing a system setting that corresponds to the option.

11. The computer system of claim 7, wherein the one or more elements include an indication corresponding to a digital assistant.

12. The computer system of claim 7, wherein the one or more elements include textual information.

13. The computer system of claim 7, wherein the computer system is configured to communicate with one or more input devices and the one or more elements include a control option, the one or more programs further including instructions for:
while displaying the control option overlaid on a portion of content, detecting, via the one or more input devices, an input corresponding to activation of the control option; and
in response to detecting the input corresponding to activation of the control option, performing an operation corresponding to the control option.

14. The computer system of claim 7, wherein:
the determination that the one or more elements are at least partially overlaid on a portion of content displayed with a brightness that is within the standard range of brightness for the display generation component includes a determination that an area adjacent to the one or more elements is displayed with a brightness that is within the standard range of brightness for the display generation component; and
the determination that the one or more elements are at least partially overlaid on a portion of content displayed with a brightness that is above the standard range of brightness for the display generation component includes a determination that the area adjacent to the one or more elements is displayed with a brightness that is above the standard range of brightness for the display generation component.

15. The computer system of claim 1, the one or more programs further including instructions for:
displaying, via the display generation component, a representation of an image, wherein the representation of the image includes at least a first portion that corresponds to a portion of the image that has a target brightness that is outside of the standard range of brightness for the display generation component, including:
in accordance with a determination that the representation of the image is displayed in an expanded state, displaying, via the display generation component, the representation of the image with a brightness that is above the standard range of brightness for the display generation component; and
in accordance with a determination that the representation of the image is not displayed in the expanded state, displaying, via the display generation component, the representation of the image with a brightness that is within the standard range of brightness for the display generation component.

16. The computer system of claim 1, the one or more programs further including instructions for:
detecting a brightness change event; and
in response to detecting the brightness change event:
changing a system brightness level of the display generation component based on the brightness change event; and
changing a headroom for brightness above the standard range of brightness of the display generation component.

17. The computer system of claim 16, wherein the change of the headroom has a non-linear relationship to the change in system brightness level.

18. A non-transitory computer-readable storage medium storing one or more programs configured to be executed by one or more processors of a computer system that is in communication with a display generation component, the one or more programs including instructions for:
detecting an event corresponding to a request to display a user interface that has an appearance that is based on the event; and
in response to detecting the event, displaying, via the display generation component, a user interface that has an appearance that is based on the event, wherein the user interface includes first content that includes at least a portion that has a target brightness that is outside of a standard range of brightness for the display generation component, including:
in accordance with a determination that the first content is in a foreground, displaying, via the display generation component, the first content with a brightness that is above the standard range of brightness for the display generation component; and
in accordance with a determination that the first content is not in the foreground, displaying, via the display generation component, the first content with a brightness that is within the standard range of brightness for the display generation component.

19. A method, comprising:
at a computer system that is in communication with a display generation component:
detecting an event corresponding to a request to display a user interface that has an appearance that is based on the event; and
in response to detecting the event, displaying, via the display generation component, a user interface that has an appearance that is based on the event, wherein the user interface includes first content that includes at least a portion that has a target brightness that is outside of a standard range of brightness for the display generation component, including:
in accordance with a determination that the first content is in a foreground, displaying, via the display generation component, the first content with a brightness that is above the standard range of brightness for the display generation component; and
in accordance with a determination that the first content is not in the foreground, displaying, via the display generation component, the first content with a brightness that is within the standard range of brightness for the display generation component.
